(19) United States
(12) Patent Application Publication
(10) Pub. No.: US 2024/0302115 A1
(43) Pub. Date: Sep. 12, 2024

(54) APPARATUS AND METHOD FOR FLUID COOLING

(71) Applicant: Empig AS, Trondheim (NO)

(72) Inventors: Fredrik LUND, Trondheim (NO); Lars S STROMMEGJERDE, Ranheim (NO); Martin KVERNLAND, Trondheim (NO); Per Jonny NUTUDAL, Trondheim (NO)

(21) Appl. No.: 18/268,990

(22) PCT Filed: Dec. 22, 2021
(86) PCT No.: PCT/EP2021/087173

§ 371 Date: Jun. 22, 2023

(30) Foreign Application Priority Data
Dec. 23, 2020 (GB) 2020494.7

(51) Int. Cl. F28G 13/00; F17D 3/01; F28D 1/047

(52) U.S. Cl. CPC F28G 13/005; F17D 3/01; F28D 1/0475

(57) ABSTRACT

The invention provides a cooler apparatus and a method use. The cooler apparatus has at least one heat exchange conduit passing through a cooling medium. The method comprises flowing a fluid to be cooled through the at least one heat exchange conduit from a first cooler inlet to a first cooler outlet, to cool the fluid from an inflow temperature to an exit temperature by heat exchange with the cooling medium. In an aspect of the invention, the flow of the fluid through the at least one heat exchange conduit and the flow of the cooling medium are controlled to cause a local increase in a temperature in a selected portion of the at least one heat exchange conduit. This causes deposits of solids to be released from an inner surface of the selected portion of the at least one heat exchange conduit into the flowing fluid. The method may comprise restricting or containing the cooling medium around the selected portion of the at least one heat exchange conduit, and/or controlling the flow of the fluid to be cooled by re-routing the flow path of the fluid through a selected inlet of the at least one heat exchange conduit.

The present invention relates to an apparatus and method for fluid cooling, and in particular but not exclusively the cooling of single phase gas or liquid and/or multiphase fluids in hydrocarbon flow systems. More specifically, the invention relates to apparatus and methods for fluid cooling which address challenges associated with deposits of solid materials in fluid cooler systems. Aspects of the invention include a cooler apparatus for a hydrocarbon flow system and methods of cooling a fluid in a hydrocarbon flow system, and a method of configuring a cooler apparatus for a hydrocarbon flow system. Aspects of the invention have particular application to subsea hydrocarbon flow systems in which seawater is the surrounding cooling medium in the heat exchange system. However, aspects of the invention also have application to cooler systems in other environments, including topsides or onshore active or passive cooler systems, in which the cooling medium in the heat exchange system may be water, air, oil or another cooling fluids such as glycol.

### BACKGROUND TO THE INVENTION

In the field of oil and gas production and transportation, flow assurance is a term used to relate to the various methods, technologies and strategies that ensure that the flow of hydrocarbons from the reservoir to the point of sale is economically feasible and uninterrupted (efficient). In near-host or on onshore production environments, various flow assurance methods are known, including mechanical, thermal and chemical processes. Particular difficulties exist in subsea production environments, where distances between wellheads and topside production facilities make flow assurance challenging, costly, and with high environmental impact. Current flow assurance technology represents a major cost driver in the oil and gas industry, and represents a limitation to pipeline reach and in the economics of field development.

A typical flow assurance problem addressed by the invention is the build-up of compounds including waxes and hydrates (and to a lesser extent, asphaltenes, nephtenates, higher paraffins, and combinations of these compounds), and/or scaling due to build-up of salts, minerals and sulphates. Hydrates that are naturally formed will be in the form of gas and water, forming a slurry phase (unstable) first, then can form a solid material or plug. Build-ups or deposits of such materials must be dealt with to reduce their impact on production rates and avoid clogging of the flowlines, pipes and production equipment.

Waxes start to form in a hydrocarbon fluid when the fluid cools to and below the Wax Appearance Temperature (WAT) of that fluid, or on a relatively cold pipe wall even when the bulk flow of fluid is above the WAT. Hydrates begin to form at the (pressure dependent) Hydrate Equilibrium Temperature (HET). Known methods of flow assurance include efforts to keep the flowing hydrocarbon warm and/or the formation of solids inhibited with chemicals such as mono-ethylene glycol (MEG). These methods require additional infrastructure such as flowline insulation, pipeline trenching, electrical heating, power supply, chemical injection and recovery points, injection lines/umbilicals, and/or cleaning regimes such as pipeline pigging and/or hot oil flushing. These known methods have various drawbacks, deficiencies, and limitations to their application, particularly over long flow distances, and can be high in cost.

Cold Flow methods are distinct from the methods by which the flowing hydrocarbon is kept warm and/or chemically inhibited; Cold Flow is conventionally the concept of cooling a hydrocarbon product down to ambient or near-ambient temperature, allowing one to transport the product in a cold, inert and stable state, with reduced requirements for chemical injection, thermal insulation on the pipes, or pipe heating and so on.

WO2004/059178 describes a method and system for transporting hydrocarbons in which the flow of hydrocarbons is mixed with another flowing fluid having a temperature below a crystallisation temperature for a precipitating solid.

WO2015/062878 describes a cold flow system which enables removal of wax and hydrate deposits by driving a vehicle bi-directionally on the cooling flowline and using inductive scan heating. This method is not equally suited to all cooler configurations; for example, it is more difficult to implement on a compact high capacity boxed manifold cooler with many stacked parallel pipes.

WO2009/051495 describes a method for removal of wax deposited on an inner wall in contact with a fluid stream, comprises cooling the inner wall and the fluid stream to a temperature of or below the wax appearance temperature, and the heating of the inner wall for a short period of time to release the deposited wax from the surface of the inner wall. The periodically high and unstable outlet temperature makes this method unsuitable for cold-flow and other cooling applications. The system is energy intensive, and would be expensive, complicated and impractical.

WO2010/110674 A2 describes a manifold cooler unit in which sections of the heat exchange conduit are cleaned by the production flow through the cooler. The system operates by shutting down sections of the manifold cooler to cause the production fluid to flow through a reduced number of open sections at higher flow rates. This fundamentally affects the operation of the cooler, resulting in an increased temperature of the fluid flowing in the cooler conduits and an increased cooler outlet temperature. The increased temperatures have the effect of removing solid deposits from the sections being cleaned. The system requires shutting down of many sections of the manifold cooler to clean a few sections, leading to inefficiencies in the cleaning process and fluctuating production pressures and/or flow rates. Furthermore, the increased outlet temperatures make the method unsuitable for some cooler applications including cold flow methods.

It has also been proposed to recycle cooled fluid from a remote side of an approximately 5 km long hydrocarbon transportation pipeline back to a near-well location on the pipeline, to shock cool the fluid flowing from the well in a mixing reactor and stimulate precipitation of hydrates in a dry and steady state into the bulk flow of fluid. This proposed method had practical difficulties due to the length of the return pipeline and was relatively inefficient as it required approximately 50% of the transported fluid to be recycled. The system would be difficult and expensive to install. It was unable to solve problems associated with wax precipitation, and had the drawback that any solids which are not precipitated into the bulk flow would result in deposits on the cool pipe walls, which could not then be easily removed.

Hot oil flushing is another way to clean pipes both topside and subsea. A volume of oil (and additives if necessary) is heated in a tank topside and pumped into the pipes to clean them of deposits and contaminants. This flushing may be performed regularly in some fields. Hot oil flushing systems require complicated and expensive infrastructure and equipment such as tanks, heaters, pumps and often extra piping (loops) for fluid circulation and return flow. Production is usually interrupted or stopped during the process. For longer distances this method becomes increasingly complex and expensive and is not suited for equipment far from the host or topside facility.

### SUMMARY OF THE INVENTION

There is generally a need for an apparatus and method which addresses one or more of the flow assurance problems identified above.

It is amongst the aims and objects of the invention to provide an apparatus and method for cooling fluids and which obviates or mitigates one or more drawbacks or disadvantages of the prior art.

In particular, one aim of an aspect of the invention is to provide an apparatus and/or method of use which addresses the precipitation and deposition of solids, including but not limited to waxes and/or hydrates, in a hydrocarbon flow system.

An aim of an aspect of the invention is to provide an apparatus and/or method of use which enables effective and/or efficient cleaning of deposits formed on the interior surfaces of cooler apparatus and systems.

An aim of an aspect of the invention is to provide an apparatus and/or method of use which uses thermal energy of a process fluid to clean of deposits formed on the interior surfaces of cooler apparatus and systems.

An aim of an aspect of the invention is to provide an apparatus and/or method of use which facilitates continuous production and/or process of fluids through cooler systems with substantially stable cooler exit temperatures.

An aim of an aspect of the invention is to provide a cooler apparatus and/or method of use that accounts for varying production rates, fluid compositions, temperature variations and/or other parameters that may change during a fluid cooling operation (for example over the field life of a hydrocarbon producing well).

Further aims and objects of the invention will become apparent from reading the following description.

According to a first aspect of the invention, there is provided a method of cooling a fluid using a cooler apparatus having at least one heat exchange conduit passing through a cooling medium, the method comprising:
flowing a fluid to be cooled through the at least one heat exchange conduit from a first cooler inlet to a first cooler outlet, to cool the fluid from an inflow temperature to an exit temperature by heat exchange with the cooling medium;
controlling the flow of the fluid through the at least one heat exchange conduit and the flow of the cooling medium, to cause a local increase in a temperature in a selected portion of the at least one heat exchange conduit, thereby releasing deposits of solids from an inner surface of the selected portion of the at least one heat exchange conduit into the flowing fluid.

The method operates by utilising thermal energy from a process fluid in a portion of the heat exchange conduit, to cause release of one or more solid materials deposited on an inner surface of the cooler into the flowing fluid. This is achieved by controlling the flow of system fluids during removal phases (or cleaning phases) of the cooling operation.

Controlling the flow of fluid and/or the flow of the cooling medium may comprise manipulating, redirecting, pumping, restricting and/or containing the flow of fluid and/or the flow of the cooling medium.

In this aspect of the invention, the flow of process fluid and the flow of the cooling medium are both controlled. However, in some aspects, either the flow of fluid or the flow of the cooling medium is controlled to cause the local increase in a temperature of the selected portion of the heat exchange conduit.

The selected portion of the heat exchange conduit may be a portion of the conduit which is liable to have solid deposits precipitated on its inner surfaces due to cooling of the fluid to the Wax Appearance Temperature (WAT) or (pressure and temp dependent) Hydrate Equilibrium Temperature (HET), or due to relatively cold walls when the bulk flow of fluid is above the WAT and/or HET. The selected portion may be displaced from a first cooler inlet in a downstream direction.

The method may comprise changing the flow of the fluid and/or the flow of the cooling medium to cause a local increase in a temperature in a second selected portion of the heat exchange conduit, thereby removing deposits of solids from an inner surface of second portion the heat exchange conduit into the flowing fluid. Thus, the method may comprise removing deposits from an inner surface of a first portion the heat exchange conduit during a first removal phase, and removing deposits from an inner surface of the second selected portion the heat exchange conduit during a second removal phase. The method May comprise changing the flow of the fluid and/or the flow of the cooling medium to cause a local increase in a temperature in third, fourth and/or further selected portions of the heat exchange conduit, thereby removing deposits of solids from an inner surface of the third, fourth and/or further selected portions of the heat exchange conduit into the flowing fluid during third, fourth or further removal phases. During second, third, fourth and/or further removal phases, the method may comprise controlling both or only one of the flow of fluid and/or the flow of the cooling medium, irrespective of the flow control of the other removal phase or phases.

Preferably, the method comprises changing the flow of the fluid and/or the flow of the cooling medium cyclically, to cause a cycle of local increases in a temperature in a plurality of selected portions of the heat exchange conduit. The plurality of selected portions of the heat exchange conduit may therefore be cyclically cleaned.

As noted above, the method may comprise manipulating, redirecting, pumping, restricting and/or containing the flow of fluid around the heat exchange conduit. The cooler apparatus may comprise an at least partially contained cooling medium and may for example be a shell-and-tube cooler, a pipe-in-pipe cooler, or a boxed or shelled cooler.

The method may comprise restricting or containing the cooling medium around the selected portion of the at least one heat exchange conduit, to cause the local increase in a temperature. The method may comprise enclosing, or partially enclosing, a volume of cooling medium surrounding at least a part of the selected portion of the conduit. In this way, heat flux outwards from the heat exchange conduit and the flowing fluid in the first portion is reduced or stopped, and after a period of time the heat exchange conduit and/or the flowing fluid is sufficiently warm to cause loosening or melting of solid deposits at a contact surface with a conduit surface, and their removal into the bulk flow.

The cooler apparatus may comprise a plurality of compartments, each compartment at least partially surrounding a portion of the cooler apparatus, and the method may comprise controlling the flow of the cooling medium into and/or out of a selected compartment to cause the local increase in a temperature in the selected portion of the at least one heat exchange conduit.

The method may comprise restricting or containing the convection throughflow of the cooling medium through the compartments by closing one or more gates or valves of the flow control system. The method may comprise flowing the cooling medium between a first compartment to a second compartment. The method may comprise circulating the cooling medium between a first compartment and a second compartment.

The method may comprise causing the cooling medium to flow relative to the heat exchange conduit to remove material or debris from an external surface of the heat exchange conduit. The method may comprise removing material or debris from an external surface of the cooler apparatus using an exterior cleaning system.

The method may comprise changing the flow of the cooling medium cyclically, for example by cyclically restricting or containing the cooling medium around a plurality of selected portions of the heat exchange conduit, to cause a cycle of local increases in a temperature in the plurality of selected portions of the heat exchange conduit.

The method may comprise controlling the flow of the fluid to be cooled by re-routing the flow path of the fluid to the selected portion.

In an embodiment of the invention, the method comprises re-routing the fluid to flow into the selected portion via a selected inlet. The selected inlet may be upstream of the selected portion, which may be displaced from the first cooler inlet in a downstream direction through the heat exchange conduit. The selected inlet may be at or near the selected portion of the at least one heat exchange conduit to be cleaned, and the method may comprise directing substantially uncooled fluid to the selected portion to deliver thermal energy to the selected portion. By re-routing the fluid to flow into the selected portion via a selected inlet, without flowing through a part of the cooler apparatus that was previously upstream of the selected portion, the fluid flowing into the first selected portion is relatively warm. The relatively warm fluid causes loosening or melting of solid deposits at a contact surface with a conduit surface, and their removal into the bulk flow.

Preferably, where the method comprises re-routing the fluid to flow into the selected portion via a selected inlet, the method comprises re-routing the fluid flowing in the heat exchange conduit to flow through a selected outlet. The selected outlet may be displaced from the first cooler outlet in a downstream direction through the heat exchange conduit. The displacement of the selected outlet may correspond to the displacement of the selected inlet. Thus the length of a cooler flow path from the selected inlet to the selected outlet may correspond to the length of the cooler flow path from the first cooler inlet to the first cooler outlet. The method may comprise selecting the outlet to maintain an exit temperature within a desired temperature range. An exit temperature of the selected outlet may be the same, or substantially the same, as the exit temperature of the first cooler outlet.

The method may comprise changing the flow of the fluid cyclically, for example by cyclically re-routing the fluid to flow into a plurality of selected portions via respective inlets, to cause a cycle of local increases in a temperature through the plurality of selected portions of the heat exchange conduit. Preferably, cycling through selected portions also comprises cycling through selected corresponding outlets.

The method may comprise directing flow of fluid to an inlet position selected from a plurality of inlet positions, and causing a local increase in a temperature in a selected portion of the heat exchange conduit at and/or downstream of the inlet position. Preferably the method comprises selecting a corresponding outlet position for the fluid.

The method may comprise changing the flow of fluid to direct it to a different inlet position selected from the plurality of inlet positions, and causing a local increase in a temperature in a different selected portion of the heat exchange conduit at and/or downstream of the inlet position. The method may comprise repeatedly changing the flow of fluid to cycle through a plurality of different inlet positions, and preferably a plurality of different outlet positions.

The method may comprise controlling the flow of fluid using one or more flow control components, which may comprise one or more valves. The method may comprise operating one or more valves to selectively direct flow of fluid to selected portions of the heat exchange conduit. The method may comprise operating one or more valves to selectively open and/or close one or more outlets corresponding to selected inlets.

The cooler apparatus may comprise a plurality of heat exchange conduits operating in parallel, and the selected portion may be a selected heat exchange conduit of the plurality of heat exchange conduits. The method may comprise directing fluid from the selected heat exchange conduit to a second inlet, to flow into another of the plurality of heat exchange conduits.

According to a second aspect of the invention there is provided a cooler apparatus comprising:
at least one heat exchange conduit passing through a cooling medium, the at least one heat exchange conduit comprising a first cooler inlet and a first cooler outlet, arranged to cool a process fluid from an inflow temperature to an exit temperature by heat exchange with the cooling medium;
a flow control system for controlling the flow of the process fluid and the flow of the cooling medium to cause a local increase in a temperature in a selected portion of the cooler apparatus, thereby releasing deposits of solids from an inner surface of the selected portion of the at least one heat exchange conduit into the flowing fluid.

The cooler apparatus may comprise a plurality of pipe sections defining the at least one heat exchange conduit. At least some of the plurality of pipe sections may be configurable to be fluidly connected in series to form a heat exchange conduit from the plurality of pipe sections. At least some of the plurality of pipe sections may be operable in parallel to form a plurality of heat exchange conduits from the plurality of pipe sections.

The cooler apparatus may comprise a plurality of compartments, each compartment at least partially surrounding a portion of the at least one heat exchange conduit, and wherein the flow control system is configured to control the flow of the cooling medium into and/or out of a selected compartment to cause the local increase in a temperature in the selected portion of the at least one heat exchange conduit.

The flow control system may be operable to restrict or contain throughflow of the cooling medium through the compartments by closing one or more gates or valves.

The plurality of compartments may be arranged to enable the cooling medium to flow between a first compartment and a second compartment. The plurality of compartments may be arranged to enable fluid circulation of the cooling medium between a first compartment and a second compartment.

The cooler apparatus may comprise at least one device for mixing fluid flowing through the cooler apparatus.

The cooler apparatus may comprise a cleaning system for cleaning the exterior of the cooler apparatus. The cleaning system may comprise at least one of a mechanical cleaning device, a fluid jetting cleaning device, or a vibrating cleaning device for removing material or debris from the exterior of the cooler apparatus.

The cooler apparatus may comprise outer pipework defining an annulus for a volume of the cooling medium around the at least one heat exchange conduit.

Embodiments of the second aspect of the invention may include one or more features of the first aspect of the invention or its embodiments, or vice versa.

According to a third aspect of the invention there is provided a cooler system comprising a plurality of cooler apparatuses according to the second aspect of the invention, wherein the cooler apparatuses are arranged to operate in parallel to cool the process fluid.

Embodiments of the third aspect of the invention may include one or more features of the first or second aspects of the invention or their embodiments, or vice versa.

According to a fourth aspect of the invention there is provided a cooler system comprising a plurality of cooler apparatuses according to the second aspect of the invention, wherein the cooler apparatuses are arranged to operate in series to cool the process fluid.

Embodiments of the fourth aspect of the invention may include one or more features of the first to third aspects of the invention or their embodiments, or vice versa.

According to a fifth aspect of the invention there is provided a subsea flow system comprising a source of hydrocarbon fluids, at least one cooler apparatus according to the second aspect of the invention, wherein the at least one cooler apparatus is fluidly connected to the source for receiving hydrocarbon fluids to be cooled, and an exit flowline for receiving cooled hydrocarbon fluids from the at least one cooler apparatus

The subsea flow system may comprise a plurality of cooler apparatuses according to the second aspect of the invention, wherein the cooler apparatuses are arranged to operate in parallel to cool the hydrocarbon fluids.

Embodiments of the fifth aspect of the invention may include one or more features of the first to fourth aspects of the invention or their embodiments, or vice versa.

In this first aspect of the invention, the flow of process fluid and the flow of the cooling medium are both controlled. However, in some aspects, either the flow of fluid or the flow of the cooling medium is controlled to cause the local increase in a temperature of the selected portion of the heat exchange conduit.

According to a sixth aspect of the invention, there is provided a method of cooling a fluid using a cooler apparatus having a heat exchange conduit passing through a cooling medium, the method comprising:
flowing a fluid to be cooled through the heat exchange conduit from a primary cooler inlet to a primary cooler outlet, to cool the fluid from an inflow temperature to an exit temperature by heat exchange with the cooling medium;
controlling the flow of the cooling medium to cause a local increase in a temperature in a selected portion of the heat exchange conduit at and/or downstream of the inlet position, thereby releasing deposits of solids from an inner surface of the selected portion of the heat exchange conduit into the flowing fluid.

Embodiments of the sixth aspect of the invention may include one or more features of the first to fifth aspects of the invention or their embodiments, or vice versa.

According to a seventh aspect of the invention, there is provided a cooler apparatus comprising:
a heat exchange conduit passing through a cooling medium, the heat exchange conduit comprising a first cooler inlet to a first cooler outlet, to cool the fluid from an inflow temperature to an exit temperature by heat exchange with the cooling medium;
a flow control system for controlling the flow of the cooling medium to cause a local increase in a temperature in a selected portion of the heat exchange conduit, thereby releasing deposits of solids from an inner surface of the selected portion of the heat exchange conduit into the flowing fluid.

Embodiments of the seventh aspect of the invention may include one or more features of the first to sixth aspects of the invention or their embodiments, or vice versa.

According to an eighth aspect of the invention, there is provided a method of cooling a fluid using a cooler apparatus having a heat exchange conduit passing through a cooling medium, the method comprising:
flowing a fluid to be cooled through the heat exchange conduit from a primary cooler inlet to a primary cooler outlet, to cool the fluid from an inflow temperature to an exit temperature by heat exchange with the cooling medium;
directing flow of fluid to an inlet position of the heat exchange conduit selected from a plurality of inlet positions, and causing a local increase in a temperature in a selected portion of the heat exchange conduit at and/or downstream of the inlet position, thereby releasing deposits of solids from an inner surface of the selected portion of the heat exchange conduit into the flowing fluid.

Embodiments of the eighth aspect of the invention may include one or more features of the first to seventh aspects of the invention or their embodiments, or vice versa.

According to a ninth aspect of the invention there is provided a cooler apparatus comprising:
a heat exchange conduit passing through a cooling medium, the heat exchange conduit comprising a plurality of inlet positions and at least one outlet position; and a flow control system for directing flow of fluid to an inlet position selected from the plurality of inlet positions, to cause a local increase in a temperature in a selected portion of the heat exchange conduit at and/or downstream of the inlet position, thereby releasing deposits of solids from an inner surface of the selected portion of the heat exchange conduit into the flowing fluid.

Embodiments of the ninth aspect of the invention may include one or more features of the first to eighth aspects of the invention or their embodiments, or vice versa.

According to a tenth aspect of the invention, there is provided a method of cooling a fluid using a cooler apparatus having a heat exchange conduit passing through a cooling medium, the method comprising:
flowing a fluid to be cooled through the heat exchange conduit from a primary cooler inlet to a primary cooler outlet, to cool the fluid from an inflow temperature to an exit temperature by heat exchange with the cooling medium;
directing flow of fluid to an inlet position of the heat exchange conduit selected from a plurality of inlet positions, and causing a local increase in a temperature in a selected portion of the heat exchange conduit at and/or downstream of the inlet position, thereby releasing deposits of solids from an inner surface of the selected portion of the heat exchange conduit into the flowing fluid.

Embodiments of the tenth aspect of the invention may include one or more features of the first to ninth aspects of the invention or their embodiments, or vice versa.

According to a eleventh aspect of the invention there is provided a cooler apparatus comprising:
a heat exchange conduit passing through a cooling medium, the heat exchange conduit comprising a plurality of inlet positions and at least one outlet position; and
a flow control system for directing flow of fluid to an inlet position selected from the plurality of inlet positions, to cause a local increase in a temperature in a selected portion of the heat exchange conduit at and/or downstream of the inlet position, thereby releasing deposits of solids from an inner surface of the selected portion of the heat exchange conduit into the flowing fluid.

Embodiments of the eleventh aspect of the invention may include one or more features of the first to tenth aspects of the invention or their embodiments, or vice versa.

According to a twelfth aspect of the invention, there is provided a method of cooling a fluid using a cooler apparatus having one or more heat exchange conduits passing through a cooling medium, the method comprising:
flowing a fluid to be cooled through the one or more heat exchange conduits from one or more respective inlets to one or more respective outlets, to cool the fluid from an inflow temperature to an exit temperature by heat exchange with the cooling medium;
causing a local increase in a temperature in a selected portion of the cooler apparatus to release [or melt-not necessarily as a solid] deposits of solids from an inner surface of the selected portion of the cooler apparatus into the flowing fluid;
routing the flow of fluid between the one or more inlets and/or one or more outlets to maintain the exit temperature within a desired temperature range.

Embodiments of the twelfth aspect of the invention may include one or more features of the first to eleventh aspects of the invention or their embodiments, or vice versa.

According to a thirteenth aspect of the invention there is provided a cooler apparatus comprising:
one or more a heat exchange conduits passing through a cooling medium, the one or more heat exchange conduits comprising respective one or more inlets and respective one or more outlets;
a temperature control system for causing a local increase in a temperature in a selected portion of the cooler apparatus to release deposits of solids from an inner surface of the selected portion of the cooler apparatus into the flowing fluid; and
a flow control system for routing the flow of the fluid between one or more inlets and one or more outlets to maintain an exit temperature of the cooler apparatus within a desired temperature range.

Embodiments of the thirteenth aspect of the invention may include one or more features of the first to twelfth aspects of the invention or their embodiments, or vice versa.

### BRIEF DESCRIPTION OF THE DRAWINGS

There will now be described, by way of example only, various embodiments of the invention with reference to the drawings, of which:

FIG. 1 is a schematic representation of a hydrocarbon flow system incorporating a cooler apparatus in accordance with a first embodiment of the invention;

FIG. 2 is a process diagram of a cooler apparatus in accordance with an embodiment of the invention;

FIG. 3 is an isometric view of a cooler apparatus in accordance with an embodiment of the invention, and is an example of a physical implementation of the cooler apparatus of FIG. 2;

FIGS. 4A and 4B are process diagrams representing operational modes of cooler apparatus according to an embodiment of the invention;

FIGS. 5A to 5F are schematic representations of a sequence of flow control for a flowing fluid in the cooler apparatus of FIG. 3 in accordance with an embodiment of the invention;

FIGS. 6A and 6B are schematic representations of a boxed cooler apparatus in accordance with an embodiment of the invention, capable of controlling the flow of fluid through the cooler and flow of the cooling medium to induce cleaning of cooler conduits;

FIGS. 7A and 7B are process diagrams of a manifold cooler arrangement of the cooler apparatus of FIG. 2, in accordance with an embodiment of the invention;

FIGS. 8A and 8B are process diagrams of a spool cooler arrangement of the cooler apparatus of FIG. 2, used in a coolant flow control cleaning method according to an embodiment of the invention;

FIG. 9 is a schematic representation of a cooler apparatus according to an alternative embodiment of the invention;

FIGS. 10A and 10B are schematic representations of a boxed spool cooler according to an alternative embodiment of the invention;

FIG. 11 is an isometric view of a pipe-in-pipe cooler apparatus in accordance with an embodiment of the invention;

FIG. 12 is an isometric view of a cooler apparatus according to a further alternative embodiment of the invention;

FIG. 13 is a process diagram of a cooler system according to an alternative embodiment of the invention;

FIG. 14 is a process diagram of a cooler apparatus in accordance with an alternative embodiment of the invention;

FIGS. 15A to 15F are process diagrams of various steps of a transition sequence between a first flow configuration of a spool cooler to a second flow configuration;

FIGS. 16A to 16H are process diagrams of various steps of a transition sequence between a first flow configuration of a manifold cooler to a second flow configuration;

FIGS. 17A to 17H are process diagrams of various steps of a transition sequence between a first flow configuration of a spool cooler to a second flow configuration;

FIGS. 18A and 18B are schematic representations of experimental set-ups used to test principles of the invention; and

FIG. 19 is a graph showing results of measurements of temperature during testing using the experimental set-ups of FIGS. 18A and 18B.

### DETAILED DESCRIPTION OF PREFERRED EMBODIMENTS

The invention in its various aspects has particular application to hydrocarbon cooler systems for use below the surface of the sea to cool fluid produced from a subsea well, and accordingly the following description relates to subsea applications in which the cooler system is disposed on the seabed with seawater as the cooling medium in the heat exchange system. However, the invention also has application to cooler systems in other environments, including underwater, topsides or onshore active or passive cooler systems such as those on unmanned wellhead platforms (“UWPs”). The cooling medium in the heat exchange system may be seawater, freshwater, air, or another cooling fluid such as oil or glycol.

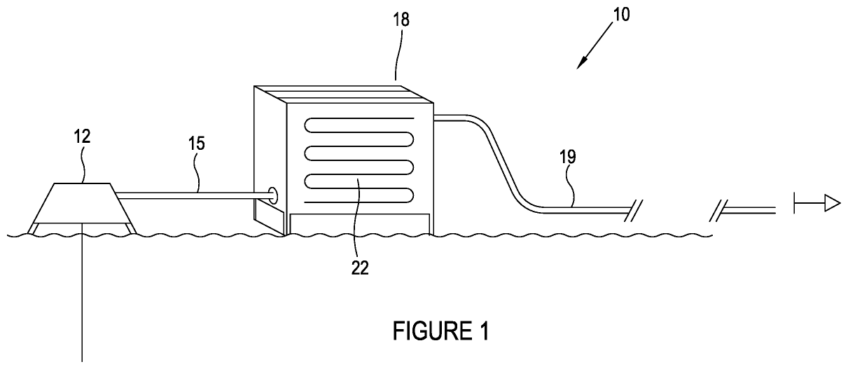

Referring firstly to FIG. 1, there is shown generally at 10 a hydrocarbon flow system comprising a subsea wellhead 12, a cooler apparatus 18, and a flowline 19. Optionally, additional subsea equipment (not shown) may be located in the flow system upstream and/or downstream of the cooler, for example separators, desanders, manifolds, pumps, slug catchers, mixers, compressors etc. The system 10 transports fluids produced from a subsea well to a Floating Production, Storage and Offloading vessel, platform or other production facility (which may be subsea, topside, offshore or onshore). In the system 10 of this embodiment, produced fluids pass from the wellhead 12 to the cooler apparatus 18 via the cooler inlet conduit 15. Optionally (not shown in FIG. 1), there may be additional subsea equipment located between the wellhead 12 and the cooler apparatus 18, for example a water separation unit, a collection manifold or other flow system components.

The cooler apparatus comprises a heat exchange conduit 22, in fluid communication with inlet conduit 15 and the production flowline 19, and passing through a cooling medium. In this example, the exterior of the heat exchange conduit 22 is exposed to the ambient seawater, which functions as the cooling medium. The cooler fluid in the cooler inlet conduit 15 typically has a temperature higher than the ambient temperature of the subsea environment. Temperatures of well fluids may be in a range of 30° C. to 200° C. (or higher or lower in some cases), with more typical examples being around of 60° C. to 100° C., and the fluids will tend to cool as they flow to the production facility, with a tendency to precipitate solids such as waxes and/or hydrates during transport, at risk to flow assurance. In a cold flow application, the cooler apparatus 18 is designed to precipitate all (or a significant proportion of) wax and hydrate within the cooler such that fluid entering the production flowline does not have (or has only limited) potential for further formation of wax and/or hydrate. The cooler apparatus can also cause the precipitation of solids from salts, sulphates and minerals that are associated with scale build-up, reducing the potential for scale forming on the export flowlines. In a standard cooler application, in which the fluids are cooled to a desired exit temperature, deposits will tend to form on the cooler conduits and will impact on the efficiency and reliability of the cooler.

In accordance with the invention, the cooler 18 is provided with means for controlling the flow of the fluid flowing through the cooler and/or the flow of the cooling medium to cause a local increase in temperature in a selected portion of the cooler, thereby removing deposits of solids from an inner surface of the heat exchange conduit into the flowing fluid.

In FIG. 1, the cooler 22 is shown as a generic subsea cooler, but the principles of the invention apply to a range of different cooler types, including but not limited to manifold coolers, spool coolers, shell-and-tube coolers, boxed or shelled coolers, pipe-in-pipe coolers, active and passive coolers, plate-coolers, and closed and open systems, including those with pipes stacked in any arrangement, such as vertical, horizontal and helical stacking. Also, as noted above, the invention also has application to cooler systems in other environments, including topsides or onshore active or passive cooler systems. The inventive principles described herein apply generally unless the context requires limitation to a particular cooler type.

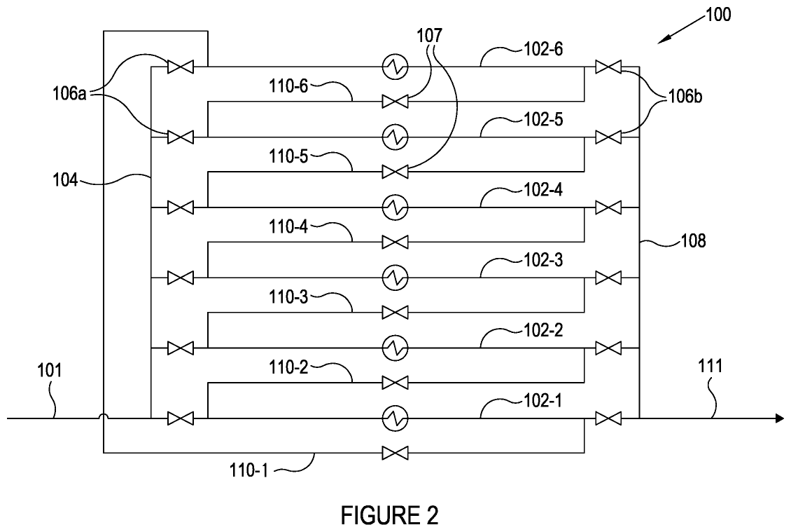

FIG. 2 is a process diagram of a cooler apparatus in accordance with an embodiment of the invention. The cooler apparatus, generally depicted at 100, comprises an inlet flowline 101 coupled to an inlet manifold 104, an outlet flowline 111 coupled to an outlet manifold 108, and a plurality of pipes 102-1 to 102-6 (together 102) disposed between the inlet and outlet manifolds. Each of the pipes 102 passes through a coolant medium, for example seawater in a subsea cooler application, and process fluid entering the cooler apparatus 100 is cooled by heat exchange with the coolant medium via the pipe walls. Controllable valves 106a, 106b are provided between the inlet manifold and each heat exchange pipe section 102, and between each heat exchange pipe section 102 and the outlet manifold. In this example, six heat exchange pipe sections 102 are disposed between the inlet and outlet manifolds.

Each heat exchange pipe section 102 also comprises a cross flow pipe 110-1 to 110-6 (together 110) that fluidly connects an outlet end of the pipe section with an inlet end of another pipe section. Each cross flow pipe is provided with a controllable valve 107.

The pipe configuration of the cooler apparatus 100 enables the cooler to be used in a number of different operational modes. For example, where multiple pipe sections 102 are open to the inlet manifold and outlet manifold by opening the respective inlet and outlet valves, the cooler apparatus can be operated as a manifold cooler, with the pipe sections 102 operating as heat exchange conduits in parallel to the process fluid flow. In another operational mode, with a single inlet valve 106a open to a selected pipe 102-6, a single outlet valve open from pipe 102-1, and the cross flow valves 107 open between the pipes 102-6 down to 102-1, the cooler apparatus can be operated as a spool cooler, with the pipe sections 102 combining to form a single heat exchange conduit through the coolant medium. In another mode of operation, cross-flow between subsets of pipe sections 102, and flow to and from each subset, creates a hybrid cooler apparatus, with multiple “spool cooler conduits” used in parallel to the process fluid flow. The cooler apparatus is highly configurable and enables a number of advantageous operational modes and cleaning methods as will be apparent from the present disclosure. It will be appreciated that the cooler apparatus 100 can be configured with a lesser or greater number of pipe sections and corresponding valves, and can be configured in a number of different physical arrangements including those with pipes stacked vertically, horizontally and helically. In addition, sections of the cooler can be shut down and/or reopened to address varying production rates, fluid compositions, temperature variations and/or other parameters that may change during a fluid cooling operation (for example over the field life of a hydrocarbon producing well).

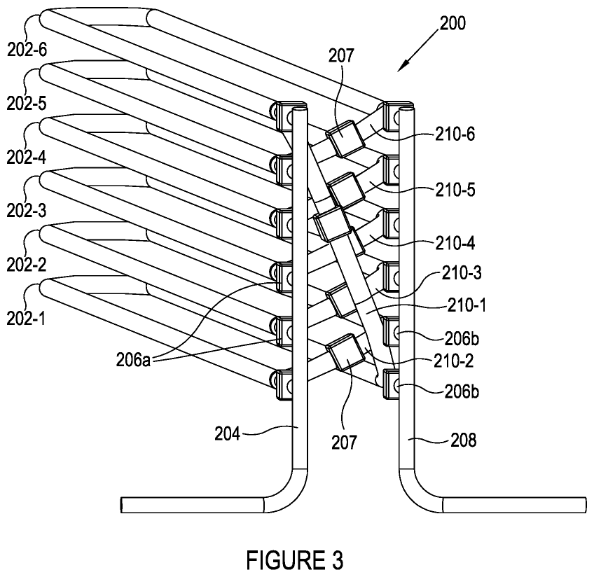

FIG. 3 is an isometric view of a cooler apparatus 200 in accordance with an embodiment of the invention, and is an example of a physical implementation of the cooler apparatus 100. The apparatus 200 comprises an inlet manifold 204, which receives the process fluid to be cooled, and is connected to pipes 202-1 to 202-6 via flow control valves 206a-1 to 206a-6. The opposite end of each pipe 202 is connected to an outlet manifold 208 via flow control valves 206b-1 to 206b-6, which flows cooled fluid from the cooler to an exit flowline. In this physical implementation, each pipe is arranged in a respective horizontal plane as a substantially U-shaped flow loop, and is vertically stacked in levels with respect to the other pipe sections 202.

Cross flow pipes 210-1 to 210-6 link an outlet end of each pipe with an inlet end of another pipe 202. In this example, cross flow pipes 210-2 to 210-6 link an outlet end with an inlet end of an adjacent pipe (i.e. the pipe in the level) immediately below. For the lowermost level (level 1), the cross flow pipe 210-1 is connected between the outlet end of the pipe 202-1 and the inlet of the pipe in the uppermost level, 202-6. It will be appreciated that this is a consequence of the spatial arrangement of pipes in an array, but that other physical arrangements of pipes, inlet and outlet manifolds, and cross-flow pipes are within the scope of the invention.

The cooler 200 is an open cooler surrounded by a cooling medium, for example seawater.

In operation, warm process or production fluid to be cooled flows into the inlet manifold 204 (for example from a subsea wellhead) and is directed into a selected pipe section 202 by opening a single inlet valve 206a between the inlet manifold and that pipe. Fluid flows around the pipe section towards the outlet end of the pipe, where it is directed to the inlet of an adjacent second pipe section via a respective cross flow pipe. The fluid will flow around the second pipe section towards the outlet end of the pipe section, where it is in turn directed to the inlet of an adjacent third pipe section and so on, until the fluid has passed through all of the pipe sections and respective cross flow pipes, to a selected outlet point on the outlet manifold. The arrangement of inlet and outlet manifolds, pipe sections 202 and cross flow pipes 210 with flow control valves 206, 207 creates a single heat exchange conduit around the cooler apparatus between a dedicated inlet and dedicated outlet formed from the pipe sections 202.

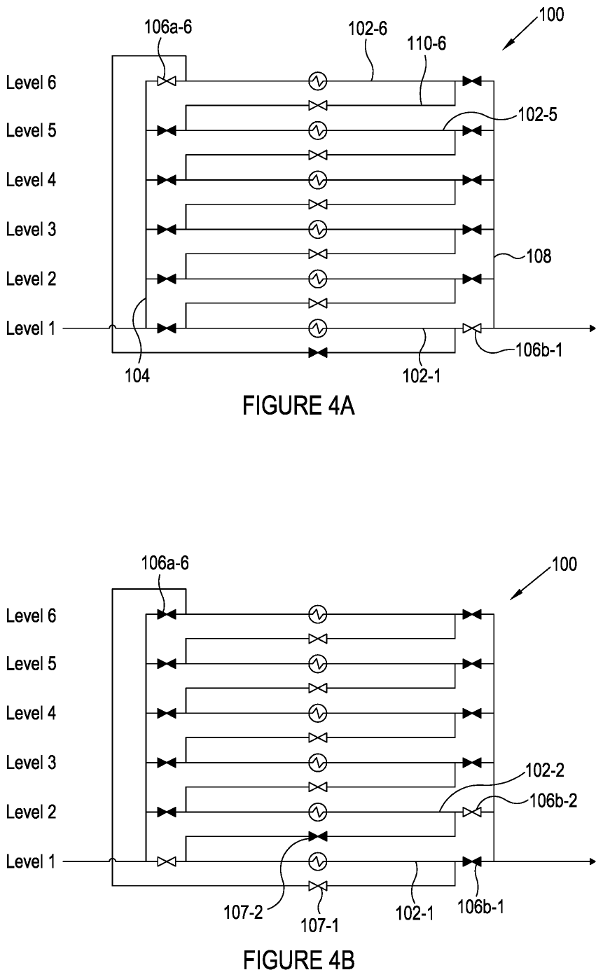

With reference to the process diagrams of FIG. 4A and FIG. 4B, an operational mode is described in which the flow of the process fluid is controlled in the cooler 100 to create a local increase in temperature to clean deposits from the cooler conduits.

In FIG. 4A, the inlet flow control valve 106a-6 associated with the pipe section 102-6 is opened to allow warm fluid to flow from the inlet manifold to the pipe section 102-6. The other inlet valves 106a remain closed. The fluid flows around the pipe section towards the outlet end, where it is directed to the inlet of pipe section 102-5 via cross flow pipe 110-6. The fluid flows around the cooler in the manner described above until it reaches the selected outlet flow control valve 106b-1 associated with pipe section 102-1 in level 1. Here the fluid exits the cooler pipe sections into the outlet manifold 108 via the open flow control valve 106b-1.

During cooling of the fluid, solid deposits such as wax and hydrates are liable to form on the interior of the conduit formed by the pipe sections. The cooler apparatus 100/200 enables solid deposits to be cleaned from the conduits of the cooler by directing the relatively warm inlet fluid stream to flow into a different part of the cooler system. The solids are released into the bulk flow of the fluid by melted into droplets or forming particles in a solid state (with shear forces from the flow assisting in removing some material as it becomes softer and/or looser).

FIG. 4B shows a changed flow route of the fluid in a different phase of the cooler flow. In this phase, the inlet flow control valve 106a-6 associated with the pipe section 102-6 has been closed, and the inlet flow control valve 106a-1 associated with the flow loop 102-1 has been opened to allow warm fluid to flow from the inlet manifold to the pipe section 102-1. The outlet valve 106b-1 is closed, as is the cross flow valve 107-2, and the cross flow valve 107-1 is open to enable flow of fluid from the outlet end of the pipe section 102-1 to the inlet end of the pipe section 102-6 via cross-flow pipe 110-1. The fluid flows around the flow loop created by the pipe sections until it reaches the selected open outlet flow control valve 106b-2 associated with pipe section 102-2. Here the fluid exits the cooler flow loops into the outlet manifold 108.

During this phase of flow, the relatively warm inlet fluid enters the pipe section 102-1 (being the selected portion of the heat exchange conduit for cleaning). In the earlier flow phase, partially cooled fluid was flowing through the pipe section 102-1, forming deposits on the inner surfaces of the cooler conduit in this section. The relatively warm inlet flow creates a local increase in the internal temperature, sufficient to melt and/or loosen solid deposits from the cooler conduit and release the deposits into the bulk flow of fluid.

After a period of operation in the phase shown in FIG. 4B, the process is repeated, by moving the inflow position of the warm fluid to enter another selected portion of the heat exchange conduit, and cause it to be cleaned.

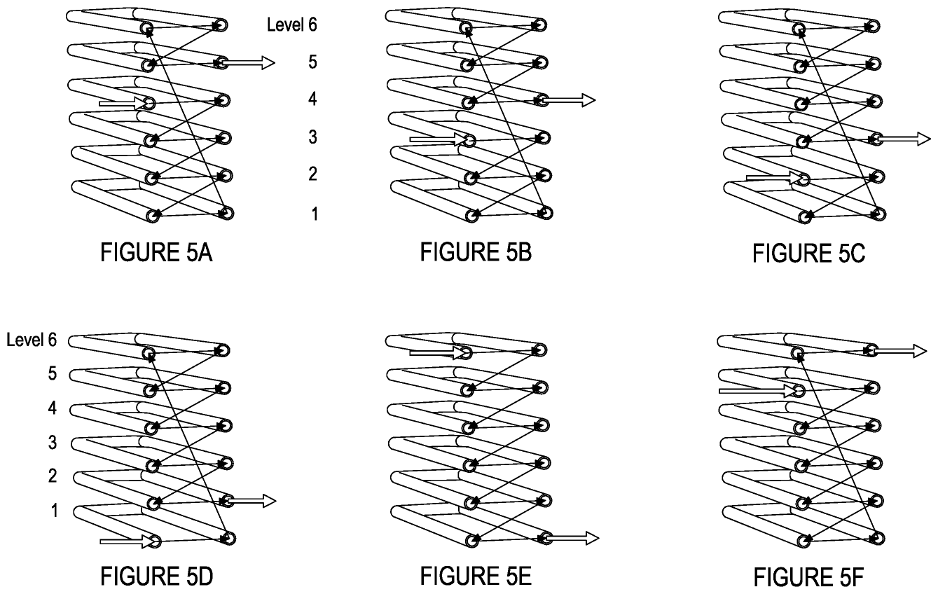

FIGS. 5A to 5F are representations of a flow control sequence in the cooler apparatus 200. In FIG. 5A, the inlet position of the heat exchange conduit is at level 4, within the outlet at level 5, causing cleaning of the level 4 pipe section. In FIG. 5B, the inlet and outlet positions are at levels 3 and 4 respectively, cleaning the level 3 pipe section, and in FIGS. 5C to 5F, the inlet and outlet are cyclically moved from levels 2 and 3 through to levels 5 and 6, sequentially cleaning the pipe sections in levels 2, 1, 6 and 5. This process can be repeated to create a cyclical movement of inlet positions through the whole heat exchange conduit of the cooler apparatus, to clean selected portions of the conduit in a continuous cleaning cycle.

Although it is the movement or selection of the fluid inlet that enables cleaning of the cooler apparatus, it is preferred to move the outlet position by a corresponding amount to maintain the length of the flow path through the cooler system and therefore enable a stable outlet temperature. In addition, to facilitate a stable inert and low temperature outlet flow in a cold flow application, it is beneficial to direct the flow through most of (or all of) the cooler length, and to position the cold outlet a significant distance as far away from the warm inlet and cleaning process.

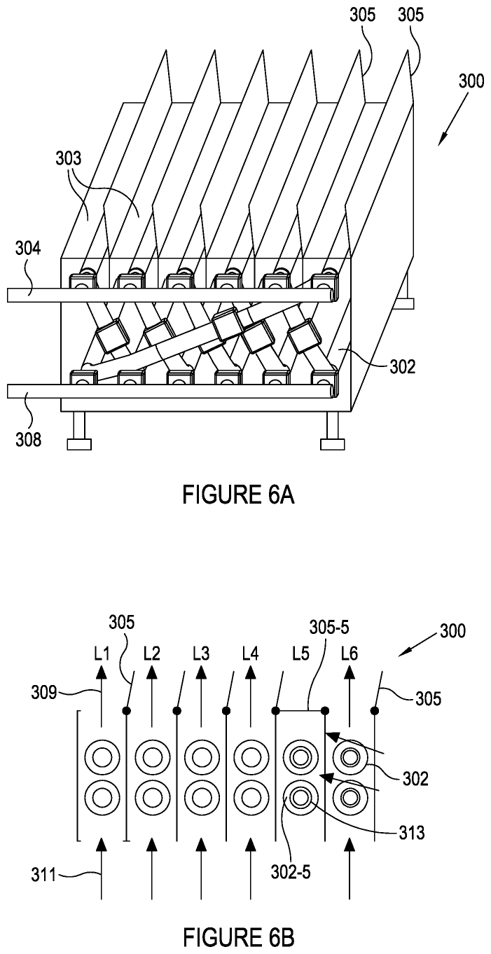

Referring now to FIGS. 6A and 6B, an alternative embodiment of the invention is described, in the form of a boxed cooler 300, with a partially contained cooling medium (in this case seawater). FIG. 6A is a schematic isometric view of the cooler 300, and FIG. 6B is a sectional view in a particular mode of operation. The cooler apparatus 300 is similar to the cooler apparatus 200 and will be understood from FIGS. 2 and 3, the accompanying description. The cooler 300 differs from the cooler 200, in that the pipe sections 302 are arranged in vertical planes in a horizontal array. In addition, the cooler 300 is provided with compartments 303, each containing a pipe section 302. The compartments are formed from vertical walls which surround and separate the pipe sections from one another, and are made from an insulating material, such as GFRP, or another material such as syntactic foams, rubber, polyurethane or other polymers. Front walls, sidewalls and rear walls surround the cooler (the front walls are omitted from FIG. 6A for visibility of internal components). In use, the compartments are open at the top and the bottom to the coolant medium. As the fluid flows through the heat exchange conduit, heat flux from the fluid passes outwards from the conduit to the cooling medium in the compartments. Relatively warm seawater passes out from upper openings of the compartments by convection as indicated by the arrows 309, and is displaced by relatively cool seawater entering lower openings of the compartments, as indicated by the arrows 311. Each compartment therefore functions as a chimney, with cooling medium passing through the compartment by convection.

As the fluid flows through the cooler, solid deposits are precipitated on its inner surfaces due to cooling of the fluid to or below the Wax Appearance Temperature (WAT) or (pressure dependent) Hydrate Equilibrium Temperature (HET), or due to relatively cold walls when the bulk flow of fluid is above the WAT. FIG. 6B shows precipitation of solids 313 on the inner walls of the pipe sections of the conduit in the compartment at level 5 (L5).

The cooler apparatus 300 comprises a system for controlling the flow of the cooling medium fluid in the cooler apparatus, which in this example is a series of upper gates 305, associated with the upper openings of the compartments 303. The gates 305 are in the form of mechanical flappers, actuable from a control module (not shown) to move between an open position in which coolant can freely exit the top of the compartment, and a closed position in which the coolant is retained in the compartment. In this embodiment, the compartments remain open at their lower surfaces, but it will be appreciated that other embodiments of the invention may be provided with lower gates, similarly actuable between open and closed positions. FIG. 6B shows gate 305-5 in a closed position. It will be appreciated that other forms of flow control may be used in alternative embodiments, including but not limited to sliding gates, sleeves, and sliding or rotating valves, and actuation may be mechanical, hydraulic, electric, or combinations thereof.

The operation of the cooler apparatus 300 in the removal of solid deposits to clean the cooler conduit will now be described. In the condition shown in FIG. 6A, the cooler apparatus is fully open to allow the cooling medium to flow through the compartments or chimneys by convection. In FIG. 6B, the selected compartment at L5, which contains a portion of the conduit that has a build-up of solids, has its gate closed to temporarily contain the cooling medium in the compartment. By trapping the seawater in the compartment around the pipe section 302-5 and stopping the convection current of seawater, a local increase in the temperature of the conduit is caused. The relatively warm fluid within the cooler conduit transfers thermal energy to the seawater, causing it to be warmed, insulating the portion of the conduit and slowing the outward heat flux. The conduit continues to be warmed from the flowing fluid, and after a period of containment of the cooling medium, the temperature within the heat exchange conduit increases until eventually it is high enough for the deposits of solids within the conduit to loosen or melt, and be released from the conduit into the flowing fluid. The release of the deposits therefore cleans the portion of the conduit within the compartment, restoring the performance of the portion of the cooler, removing restrictions to the flowing fluid, and preventing blockages from forming in the cooler conduit. The cooler removes wax and hydrates from the conduit into the bulk flow of fluid, and in a cold flow application, cools and prepares the production flow for long distance transfer with little or no potential for more solids to form or redeposit.

When the portion of the conduit in compartment at L5 is cleaned, the gate 305-5 is opened to restore convection flow through the compartment, and full functioning of the conduit portion in cooling the fluid. The flow control system is then operated to contain flow of the seawater in another compartment, in this case the adjacent compartment at L6, to cause a local increase in temperature and remove deposits from the corresponding portion of the conduit. Opening and closing of the compartments may be performed in a repeating sequence, to cyclically cause local increases in temperature and therefore cyclically clean portions of the conduit on which deposits have formed.

Although FIG. 6A shows all compartments being open, the apparatus will preferably be operated in a continuous cleaning mode with one (or more) compartment being closed at all times during cooling, to contain the cooling medium and clean the corresponding portion of the conduit from solid deposits. The method facilitates keeping the cooler clean at all times, which will increase its efficiency compared to normal coolers that will have a decreasing cooling efficiency. If necessary to achieve cooling to a target temperature (for example a temperature close to ambient temperature in a cold flow application, the length of the heat exchange conduit may be increased with respect to a conventional cooler apparatus by the equivalent of a length of a portion to be cleaned, to compensate for the cleaned portion (i.e. in the contained compartment) not contributing to fluid cooling in the same way as the other sections. This additional length will, in most applications, be technically and commercially viable when consideration is given to the benefits of the method. In particular, the method described above uses the naturally occurring thermal energy from the fluid to be cooled and transferred to the cooling medium to keep the system in continuous and optimal working condition, without a requirement for external heat sources, interruption to cooler operation, or other conventional flow assurance techniques.

The method described above is passive in that it relies on the controlling of convection flow in the cooling medium (seawater) without active pumping. In a variation the method can be used in combination with active heating and cooling using electricity or active pumps. For example, electrical heating could be used for certain exposed parts of the flow system such as pipes, pipe bends, valves, pumps and injection lines, sensors or anywhere control of coolant flow is challenging.

The method described above applies to any cooler application with solid deposition problems such as fouling or crystallisation in which the coolant flow can be suitably controlled. It utilises thermal energy from the process fluid to “self-clean” the cooler from within. The method is not limited to cold flow or subsea applications. The method is also applicable for topside coolers, for example those used on hydrocarbon platforms and/or FPSOs, or onshore coolers for the hydrocarbon production industry. It can be adapted for use on spool coolers, manifold coolers, shell and tube coolers, pipe-in-pipe coolers, plate type coolers, spiral coolers, coil coolers, radiator coolers and others, including active or passive systems, in any industrial application.

In one example, the cooler 300 is a manifold cooler, in which the pipe sections 302 are used in parallel to cool a process fluid flowing between the inlet and the outlet manifolds. The pipe sections 302 therefore function as separate, parallel heat exchange conduits, in this example arranged in a substantially U-shaped loop in the compartments. It will be appreciated that a greater or lesser number of pipe sections could be used in a manifold cooler arrangement, and/or a greater number of pipe sections could be arranged in each compartment, in a vertically stacked arrangement or otherwise.

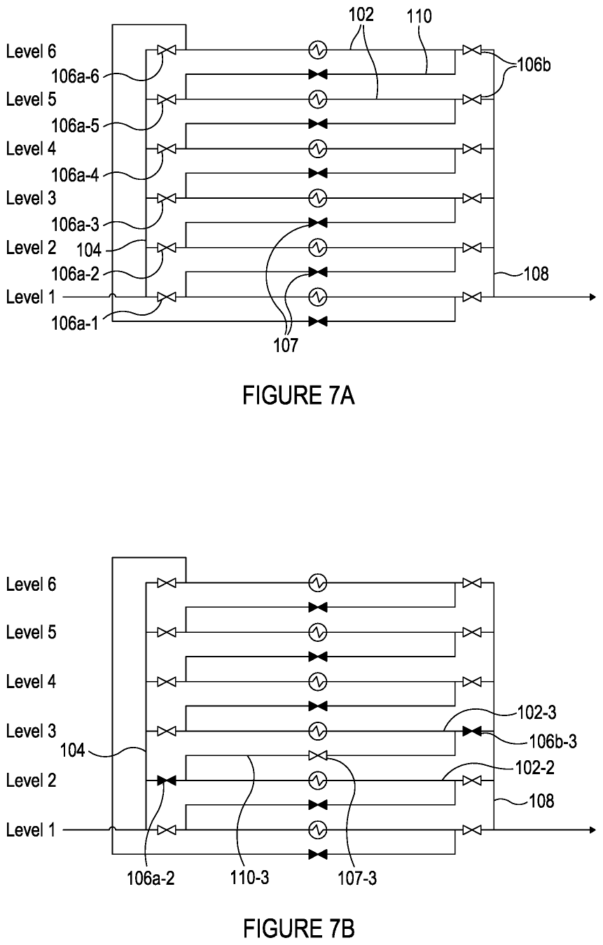

FIGS. 7A and 7B are process diagrams of a manifold cooler arrangement of the cooler apparatus 100, used in a coolant flow control cleaning method as described above. In FIG. 7A, the cooler apparatus is shown in normal production, with the inlet flow control valves 106a-1 to 106a-6 and the corresponding outlet flow control valves 106b-1 to 106b-6 open to allow warm fluid to flow from the inlet manifold 104 to the pipe sections 102, and out to the outlet manifold 108. The cross-flow pipe valves 107 remain closed. The pipe sections 102 cool the process fluid by heat exchange with the coolant medium outside the pipes.

In the operational mode shown in FIG. 7B, the pipe section 102-3 is selected to be cleaned, by controlling the flow of coolant medium outside the pipe section 102-3, to cause a local increase in the temperature of the conduit. The conduit continues to be warmed from the flowing fluid, and after a period of containment of the cooling medium, the temperature within the heat exchange conduit increases until eventually it is high enough for the deposits of solids within the conduit to loosen or melt, and be released from the conduit into the flowing fluid. During the cleaning mode, the outlet valve 106b-3 is closed, and the cross-flow valve 107-3 in the cross-flow pipe 110-3 is open. Fluid flowing through the pipe section 102-3 (which has not been cooled due to the coolant flow control) is therefore directed to the inlet end of another pipe section, in this case 102-2. The fluid flows through the pipe section 102-2, in which it is cooled by heat exchange with the surrounding coolant medium. The inlet valve 106a-2 is closed to ensure that all the fluid from pipe-section 102-3 flows through section 102-2.

In the operational mode of FIG. 7B, the fluid entering the outlet manifold from each pipe section has been cooled. In the case of the fluid from the cleaned pipe-section (which has no cooling function during cleaning), cooling is by a second pass of the fluid through a functioning pipe-section. This method of re-routing or redirecting the outlet flow from a cleaned pipe section to the inlet of another pipe section mitigates against an increase of the exit temperature of fluid flowing from the cooler apparatus. Re-routing the outlet flow in this way can be performed cyclically, in sequence with the coolant flow control to clean different sections of the cooler. Although FIG. 7A shows “normal production” in manifold configuration, the apparatus will preferably be operated in a continuous cleaning mode with one (or more) compartment being closed at all times during cooling, to contain the cooling medium and clean the corresponding portion of the conduit from solid deposits.

While FIGS. 7A and 7B describe a coolant control method in a manifold cooler configuration, in another example, the coolant flow control method can be used in a spool cooler configuration, in which the pipe sections in the compartments of the cooler are portions of a single heat exchange conduit that passes through multiple compartments. By controlling the coolant flow in one or more compartments, a selected portion of the heat exchange conduit can be cleaned. The spool cooler may be a conventional spool cooler configuration arranged with a coolant flow control system, or may be similar to the cooler 100 or 300, providing inlet and/or outlet flow control functionality operable simultaneously.

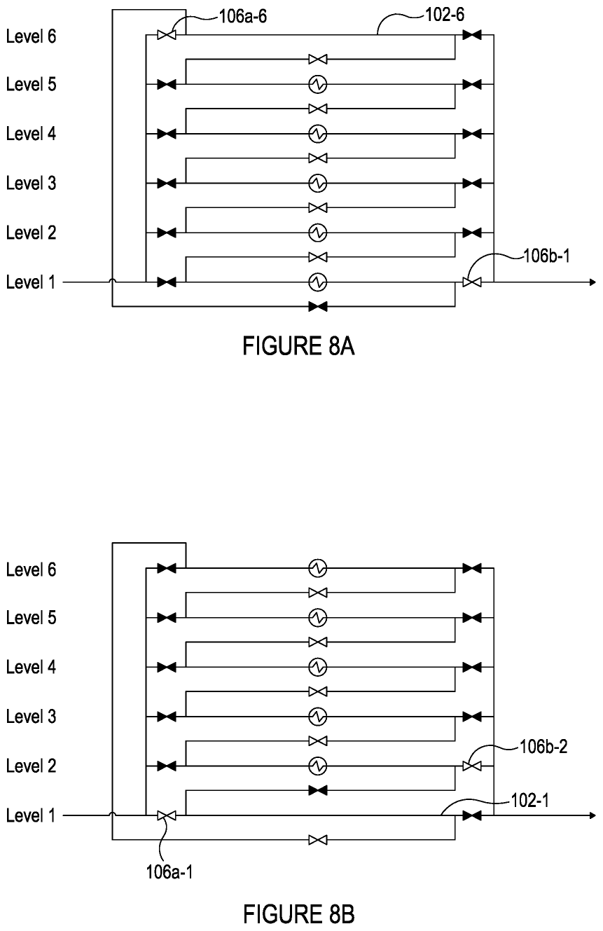

FIGS. 8A and 8B are process diagrams of a spool cooler arrangement of the cooler apparatus 100, used in a coolant flow control cleaning method as described above, in conjunction with re-routed cooler inlets and outlets as described with reference to FIGS. 4A and 4B. In FIG. 8A, the cooler apparatus is shown with the process fluid entering into the heat exchange conduit formed by the pipe sections through the valve 106a-6, while the coolant control system has contained the coolant around pipe section 102-6. Thus, warm fluid is being directed to pipe section 102-6 through the selected inlet, and heat flux from the pipe section is reduced as the contained coolant is warmed. FIG. 8B shows a flow configuration for cleaning pipe section 102-1. In FIG. 8B, the process fluid enters into the heat exchange conduit through the valve 106a-1, while the coolant control system has contained the coolant around pipe section 102-1, with the outlet re-configured at level 2. The coolant control and inlet and outlet positions can be reconfigured cyclically to systematically clean all of the pipe sections in the cooler apparatus.

This mode of operation utilises control of the process fluid in conjunction with flow control of the coolant, to heat the deposits on the pipe section from the inside while insulating the pipe section from heat loss. Controlling the inlet for the process fluid directs locally available thermal energy to pipe sections in the cooler at which cleaning is needed or desired. Controlling the coolant creates a similar effect by containing locally available thermal energy at the required pipe section. Combining the two elements improves the efficiency of creating a local increase in temperature to clean deposits from that section, and facilitates use of the system in a wider range of process flow temperatures and/or cooler configurations.

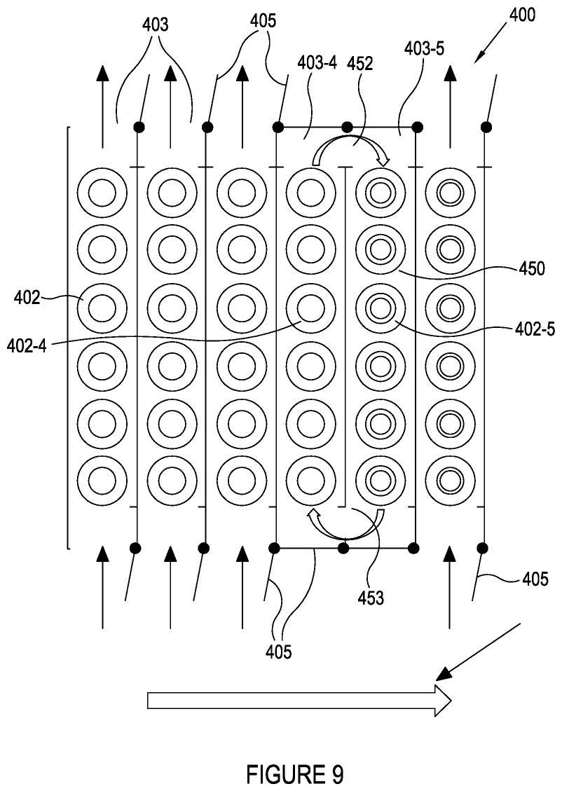

FIGS. 6A and 6B and the accompanying text describe the use of coolant compartments, where a selected compartment 308 can be closed to temporarily contain the cooling medium in the compartment, insulating the corresponding portion of the conduit to create a local increase in temperature which cleans deposits from the conduit. FIG. 9 is a schematic representation of a similar cooler apparatus, shown generally at 401, in which the compartments 403 contain multiple loops of a pipe section 402 of a spool cooler. The apparatus 400 differs from the apparatus 300 in that the flow control system is capable of sharing or displacing a volume of warmed cooling medium previously used in the cleaning of one pipe section to surround a different pipe section that requires cleaning. In the apparatus 400, this is achieved by creating an enlarged shared compartment 450 from two adjacent compartments 403-4 and 403-5.

With reference to FIG. 9, compartment 405-4 contains a volume of cooling medium that has warmed from use in the cleaning method described with reference to FIGS. 6A and 6B, and the pipe section 402-4 within the compartment 403-4 is now clean. Rather than opening a gate 405 of the flow control system to resume chimney effect convection flow of the cooling medium through the compartment 403-4, the flow control system opens ports 452 and 453 between the compartment 403-4 and an adjacent compartment 403-5, which surrounds the next portion of pipe section 402-5 to be cleaned. The cooling medium in the enlarged compartment insulates the surrounded pipe section and the temperature within the heat exchange conduit begins to increase. The ports 452, 453 may then be closed, and the gates of compartment 403-4 opened to resume coolant flow around pipe section 402-4. The gates of compartment 403-5 remain closed, to continue to insulate the pipe section until the heat flux is reduced and the temperature is high enough for the deposits of solids within the conduit to loosen or melt, and detach from the conduit into the flowing fluid.

The coolant flow control method described above shares warmed coolant with the next section to be cleaned for increased efficiency of the process. Although the coolant control methodology of the present disclosure can be used in its own right in manifold cooler, spool cooler and hybrid cooler applications, it is most effective in a spool or hybrid cooler application when used in conjunction with the re-routing of the inlet flow to the heat exchange conduit, as described for example with reference to FIGS. 3 to 5 and 8. In the method of FIG. 9, this would involve re-routing the flow inlet to the pipe section 402-5 at or after the time of sharing the coolant from compartment 403-4.

The exposure of the relatively hot cooling medium from the compartment 403-4 to the relatively cool compartment 403-5 via the upper ports 452 creates a reverse (downward) convection flow in the compartment 403-5. Relatively cold cooling medium is displaced from the compartment 403-5 through lower ports 453 and is warmed by the clean portion of the conduit in compartment 403-4, resulting in a circulating convection current in the enlarged compartment 450. This effect is enhanced by directing the flow of process fluid to enter the heat exchange conduit in the pipe section 402-5 to be cleaned.

The circulating convection current in the enlarged compartment 450 has the additional benefit of promoting removal of marine debris and/or marine snow that may have settled on the upper surfaces of the flow pipe sections, and which may reduce the effectiveness of the heat exchange processes. The reverse flow direction in the compartment 403-5 (that is, downward flow in contrast to the normal upward flow direction of convection in a single compartment) may be sufficient to loosen debris from the upper surfaces of the pipe section, which will be suspended as particles in the cooling medium before being flushed away when the compartment is fully opened.

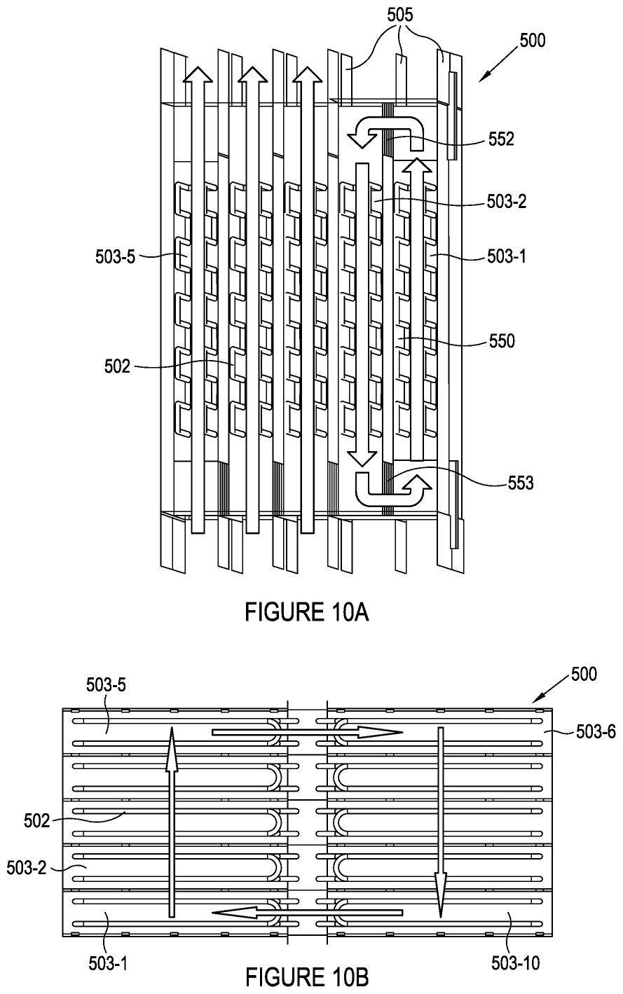

Referring now to FIGS. 10A and 10B, there is shown schematically a boxed spool cooler 500 according to an alternative embodiment of the invention. The cooler 500 is shown in an isometric view in FIG. 10A, with foremost sidewalls omitted to show internal components, and in plan view in FIG. 10B. Inlet and outlet flow manifolds and valves are also omitted from FIGS. 10A and 10B to improve the clarity of the drawings.

The cooler apparatus 500 comprises multiple compartments 503 which each contains multiple loops of a pipe section 502 of a spool cooler. Like the apparatus 400, the cooler 500 is capable of containing coolant around pipe sections with compartments 503 by the controlled operation of coolant gates 505, and is also capable of sharing or displacing a volume of warmed cooling medium previously used in the cleaning of one pipe section to surround a different pipe section that requires cleaning. This is achieved by creating enlarged shared compartments 550 from two adjacent compartments 503-1 and 503-2, by controllable opening and closing of ports 552, 553 located between adjacent compartments. The cooler 500 also has inlet and outlet repositioning functionality as described with reference to FIGS. 3 to 5 and 8.

In use, the cooler 500 shares warmed coolant from the compartment of a cleaned pipe section with an adjacent compartment selected for cleaning, and generates a reverse convection current which provides external cleaning of the pipe section. Opening and closing of the compartments, and repositioning of the inlet and outlet of the heat exchange conduit, may be performed in a repeating sequence, to cyclically cause local increases in temperature and systematically clean portions of the conduit.

FIG. 10B shows schematically the direction of cleaning of the pipe sections by the above method. The cooler 500 comprises two rows of compartments located back-to-back, and when the pipe section in compartment 503-5 has been cleaned, the coolant is shared with the opposing compartment 503-6 in the second row. The cyclical process continues, until the coolant is shared from compartment 503-10 back to compartment 503-1. The configuration shown enables external cleaning by reverse convection flow, and efficient use of warmed coolant, in a continuous process.

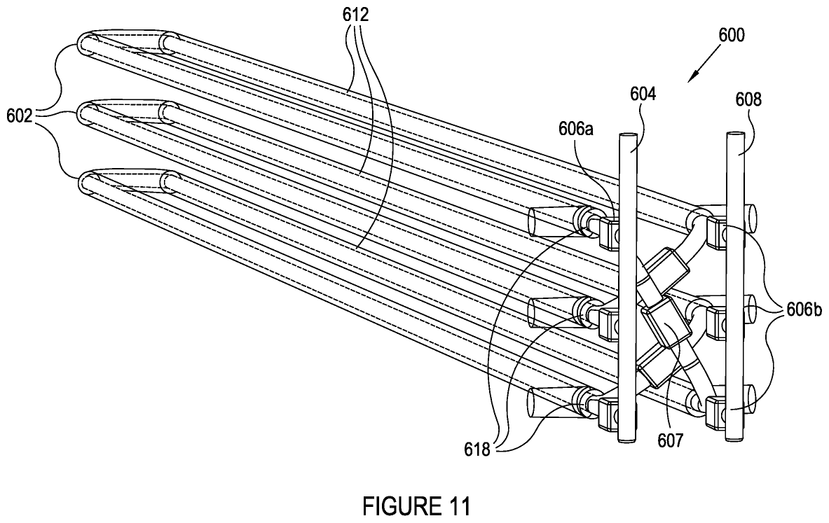

FIG. 11 is a schematic representation of an active pipe-in-pipe cooler apparatus in accordance with an embodiment of the invention. The cooler apparatus, generally shown at 600, has particular application to onshore and/or topside cooling systems, where passive natural water cooling may be unavailable. The apparatus 600 is similar to the cooler 200, and will be understood from FIGS. 3, 4A and 4B and the accompanying description.

The apparatus 600 comprises an inlet manifold 604, which receives the process fluid to be cooled, and is connected to pipe sections 602-1 to 602-3 via flow control valves 606a-1 to 606a-3. The opposite end of each pipe 202 is connected to an outlet manifold 208, which flows cooled fluid from the cooler to an exit flowline. In this physical implementation, each pipe is arranged in a respective horizontal plane as a substantially U-shaped flow loop, and is vertically stacked in levels with respect to the other pipe sections 602. Cross flow pipes 610-1 to 610-3 link an outlet end of each pipe with an inlet end of another pipe 602.

The pipe sections combine to form single heat exchange conduit (in a spool cooler configuration), multiple heat exchange conduits in parallel (in a manifold cooler configuration) or a combination of the above (in a hybrid cooler configuration).

The pipe sections 602 are arranged as an inner conduit, with outer pipework 612 surrounding the inner conduit, defining a flow annulus for a coolant medium. The outer pipework is arranged in sections, with each section surrounding a respective flow loop portion 602 of the inner conduit. The outer pipework is formed from an insulating material, such as GFRP, or another material such as syntactic foams, rubber, polyurethane or other polymers. Each section of outer pipework has an inlet 614 for receiving flow of a cooling medium and an outlet 616 for return of the cooling medium. In a preferred configuration, the cooling medium is circulated around the outer pipework via inlet and outlet manifolds (not shown) and a reservoir by one or more pumps (not shown). Flow control valves 618 enable the individual sections of the outer pipework to be isolated to contain the cooling medium in sections surrounding the inner conduit.

In use, the apparatus operates in similar manner to the apparatus 200, to enable an inlet position to of the fluid flow to be changed during different operational phases and clean separate portions of the cooler conduit. In addition, the flow control valves of the outer pipework enable the cooling medium surrounding a portion of the inner conduit to be contained, in the manner described with reference to FIGS. 6A and 6B. By introducing the fluid to be cooled into a portion of the inner conduit to be cleaned, and stopping the cooling water circulation in the outer pipework around that portion, the inner conduit is heated from the inside and insulated on the outside, causing a local increase in temperature within the selected portion of the conduit and releasing solid deposits into the flowing fluid.

Benefits of the apparatus of FIG. 11 include the relatively simple and low-cost nature of the flow components, and the ability to use robust and field proven off-the-shelf valves and controls.

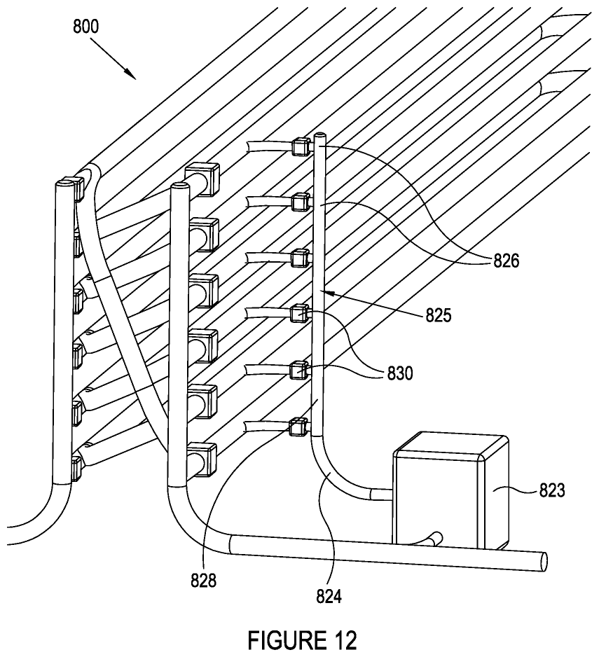

FIG. 12 is an isometric view of a cooler apparatus according to a further alternative embodiment of the invention. The cooler, generally shown at 800, is similar to the cooler 200 and its features and functions will be understood from FIGS. 3 and FIGS. 4A to 4B and the accompanying description. The cooler 800 differs from the cooler 200 in that it is provided with a system for introducing seeding particles into the cooler at one or more selected locations.

The cooler apparatus 800 comprises a return conduit 824, which is in fluid communication with the outlet manifold on the cool side of the heat exchange conduit and provides a return flow path for cooled fluid to be recycled to a secondary inlet system, generally depicted at 825. The return conduit also comprises a pump 823. The secondary inlet system enables inflow to the heat exchange conduit 822 at one or more of a number of inflow positions 826 along the length of the heat exchange conduit. In the embodiment shown, one seeding inflow position 826 is provided in each pipe section. However, in alternative embodiments (for example where a higher degree of selectivity is desirable and/or where manifold cooler flow configurations are used), more than one seeding inflow position may be provided on a pipe section. Each can receive recycled fluid from the return conduit via a manifold 828. The inlet conduits comprise flow control valves 830 to enable one or more of the potential inlets for recycled fluid to be selected.

The return fluid or recycled fluid contains solid particles already precipitated into the fluid through the cooling process, and these solid particles function as a catalyst or “seeds” for further precipitation of solids into the bulk fluid flowing in the heat exchange conduit. The optimum seeding point is determined by the temperature of the fluid in the heat exchange conduit, which is affected by the longitudinal position along the conduit from the selected inlet. If the recycled fluid from the return conduit enters the heat exchange conduit too close to the cooler inlet, the solid particles in the already cooled return fluid that are desired to act as catalysts for further precipitation will melt, as the temperature of the bulk fluid in the heat exchange conduit will be too high (i.e. higher than the Wax Appearance Temperature (WAT) and the Hydrate Equilibrium Temperature (HET). Conversely, if the recycled fluid from the return conduit enters the heat exchange conduit too far from the cooler inlet, the temperature of the bulk fluid in the heat exchange conduit will be too low, and layers of precipitated wax or hydrate will already be forming on the inner wall of the conduit. The WAT and the HET are different from one another, meaning that the optimum seeding points for wax and hydrate are different, even though the wax and hydrate seeds are recycled together.

A selectable seeding injection point is beneficial to finding the sweet spot for seeding during the life of the well, and has particular advantages in cold flow applications. In a spool cooler configuration, a single seeding inflow position on each pipe section provides a number of different seeding positions along the length of the heat exchange conduit. In addition, when the cooler 800 is configured as a spool cooler, the inlet position for the fluid to be cooled is dependent on the phase of operation, as it may be moved to different positions in the cooler conduit in order to remove deposits from a selected portion of the conduit. To maintain an appropriate inflow position for the recycled fluid, the selected inflow position or positions for the recycled fluid may also be changed during the phases of operation. In a manifold cooler configuration, in which the inlet position for the process fluid is not moved during cooling, multiple selectable seeding injection points may be provided on a pipe section to enable a choice of seeding points and repositioning of the seeding point during the operating life.

The seeding system of this embodiment can reduce the deposit rates significantly, providing greater flexibility in the choice of cleaning regime and/or the way a cleaning system is operated. For example, the frequency of cleaning operations can be reduced, and/or a lower impact cleaning system may be used. Reducing cleaning frequency will reduce power consumption which again will reduce the operating expense of the system, and may also reduce maintenance costs of the cleaning system due to reduced wear on the equipment used.

It will be appreciated that alternative systems for introducing seeding particles can be used within the scope of invention. In particular, configurations of inlet conduits may differ from that shown in FIG. 12. A greater or lesser number of inlet conduits may be used, and any suitable distribution of the inlet conduits (for example, distributed in a two or three dimensional array in the cooler apparatus) may be used to provide an appropriate selection inflow positions for effective seeding.

In embodiments of the invention, the cooler apparatus may optionally include a formation or insert (not shown) configured to disrupt the flow in at least a portion of conduit system of the cooler apparatus. The insert may be, for example, a helical coil or swirl disposed in the heat exchange conduit, and may be designed to induce turbulence in the flow. Turbulence and fluid mixing can increase the heat exchange coefficient and therefore the effectiveness of the cooler. In addition, the turbulence and fluid mixing can help accelerate crystallization of solids and result in a more complete conversion, and/or may increase the erosion of wax layers on the inner walls of the conduit, as the abrasiveness of solid particles in the fluid assists in wearing down any wax layers. Inserts can also enable turbulent flow and effective cooling in larger diameter pipes, resulting in more efficient heat exchange with higher production capacity. The insert could extend through the entire or majority of the cooler apparatus. One potential drawback of using inserts of this type is the potential for them to become clogged by deposits of precipitated solids, but this drawback is mitigated by the methods of cleaning the cooler apparatus described herein. The formations and insert may be located in parts of the conduit that can be effectively cleaned by the re-routing of the fluid to be cooled and/or controlling the flow of the cooling medium, to reverse the effect of clogging.

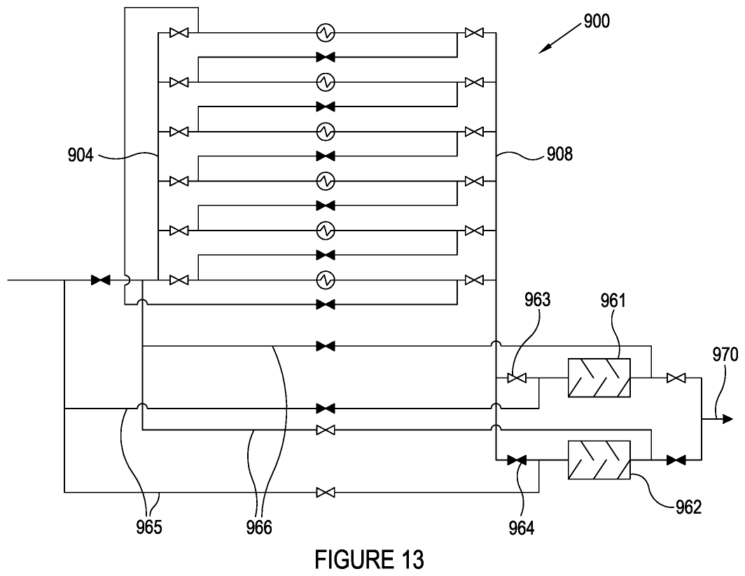

FIG. 13 is a process diagram of a cooler system 900 according to an alternative embodiment of the invention. The cooler system 900 is similar to the cooler apparatus 100, and is shown here in a manifold cooler configuration in normal production. The system 900 differs from previously described embodiments in that it is provided with additional flow mixer functionality.

The outlet manifold 904 of the system 900 is fluidly coupled to first and second mixing vessels 961, 962 by respective flow control valves 963, 964. Process fluid exiting the outlet manifold 908 can be directed to one or both of the mixing vessels before flowing to the export flowline 970. The mixing vessel functions to homogenise the outlet flow from the outlet manifold, to mitigate against the effects of uneven temperature and/or composition in the fluid, prior to flowing through the downstream production/export flowline. This may be a particular issue with manifold coolers and/or in cold flow applications, in which the temperature and composition of fluid exiting the multiple parallel cooler pipe sections is uneven. The mixing vessel functions to crystallise any rest potential for solids to form in the fluid. The mixing vessel may be also be beneficial in a spool cooler application to mitigate against the effects of water/gas slugging in the system (slug catcher functionality).

The cooler system 900 includes a cleaning flow loop for each of the mixing vessels. The cleaning flow loop comprises a cooler bypass line 965 from a position upstream of the inlet manifold 904, which enables warm process fluid to be directed from the cooler system inlet to the mixing vessel. The warm fluid causes a local increase in temperature in the mixing vessel, to remove deposits of solid materials accumulated within the vessel. A return flow line 966 enables the process fluid to flow back to the inlet manifold for flow through the cooler. The cooler being cleaned also functions as a flow mixer or slug catcher upstream of the inlet manifold and cooler apparatus, and helps to ensure homogeneous flow in the cooler.

In the embodiment shown, two mixing vessels and cleaning flow loops are provided, to enable use of one mixing vessel in homogenising the process fluid exiting the cooler conduits, while the second mixing vessel is being cleaned by the warm process fluid. It will be appreciated that in alternative embodiments a single mixing vessel could be provided, with cleaning taking place while the mixing functionality is offline, or a greater number of mixing vessels could be used. The mixing vessel may comprise baffles, turbulators, or other formations to mix and disrupt the flow, or may comprise a simple vessel with mixing taking place naturally due to residence time in the vessel. In alternative embodiments the cleaning flow loop may be supplemented with active cleaning means, such as trace heating or similar.

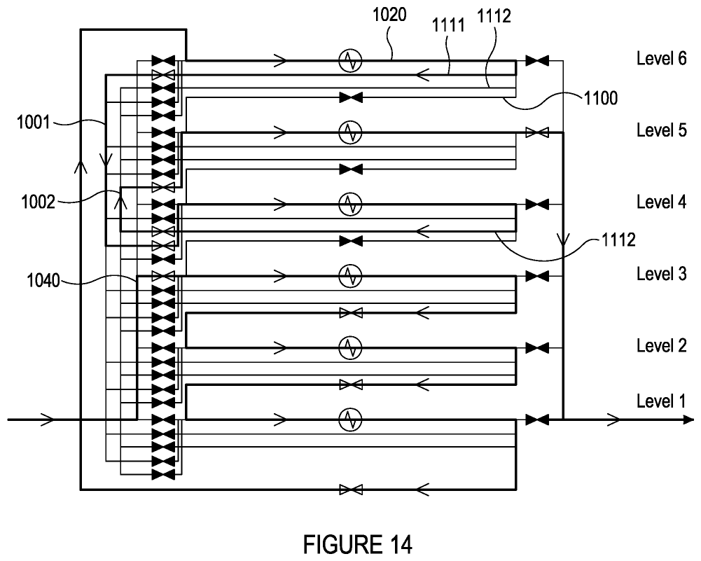

FIG. 14 is a process diagram of a cooler apparatus in accordance with an alternative embodiment of the invention. The cooler apparatus, generally shown at 1000, is based on the apparatus 100, but offers additional flow routing options. The cooler apparatus 1000 comprises a primary inlet manifold 1040 and cross-flow pipes 1101 to 1106 joining the outlet end of a pipe section with an inlet end of an adjacent pipe section, in common with the cooler 100. The cooler 1000 comprises additional cross-flow inlet manifolds 1001, 1002, and additional cross-flow pipes 1111, 1112, joining the outlet end of each pipe section with a respective cross-flow inlet manifold 1001, 1002. The cooler 1000 adds flexibility to the system, for enabling routing between the outlet end of any of the pipe sections 1020 to the inlet of any other pipe section, via the cross-flow pipes and cross-flow manifolds. In the example of FIG. 13, process fluid is routed into the cooler via the pipe section at level three, and is directed to flow through the pipe sections in level 2, level 1, and level 6, in the manner described with reference to FIGS. 4A and 4B. However, after flowing through the pipe section in level 6, the fluid is directed to the cross-flow inlet manifold 1001 via cross-flow pipe 1111, and subsequently to the pipe section at level 4. After flowing through the pipe section in level 4, the fluid is directed to the cross-flow inlet manifold 1002 via cross-flow pipe 1112, and subsequently to the cooling pipe section at level 5.

The cooler 1000 enables a number of operational benefits, including full flexibility in the selection of pipe sections to be cleaned and variations to the cleaning cycles. The cooler 1000 enables complete flexibility in configuring the apparatus as a spool cooler, a manifold cooler, or a hybrid of a spool and manifold cooer. Alternatively, or in addition, sections of the cooler can be shut down and/or reopened with full flexibility, providing further improvements in addressing varying production rates, fluid compositions, temperature variations and/or other parameters that may change during a fluid cooling operation (for example over the field life of a hydrocarbon producing well). Another benefit is that a part of the cooler that does not need cleaning (for example at the hot end of the cooler system in a high temperature oil and gas field) can be operated as a precooler far above the WAT and/or HET.

The foregoing description discloses how different cooler configurations may be used in particular modes of operation for effective cooling and self-cleaning using energy from the process fluid itself. It is advantageous for the coolers described to be re-configured from one operational phase to another without causing large fluctuations in the exit temperature of the fluid and process fluid pressure. One way to mitigate against the effects of reconfiguring the flow system is use appropriate transition methods.

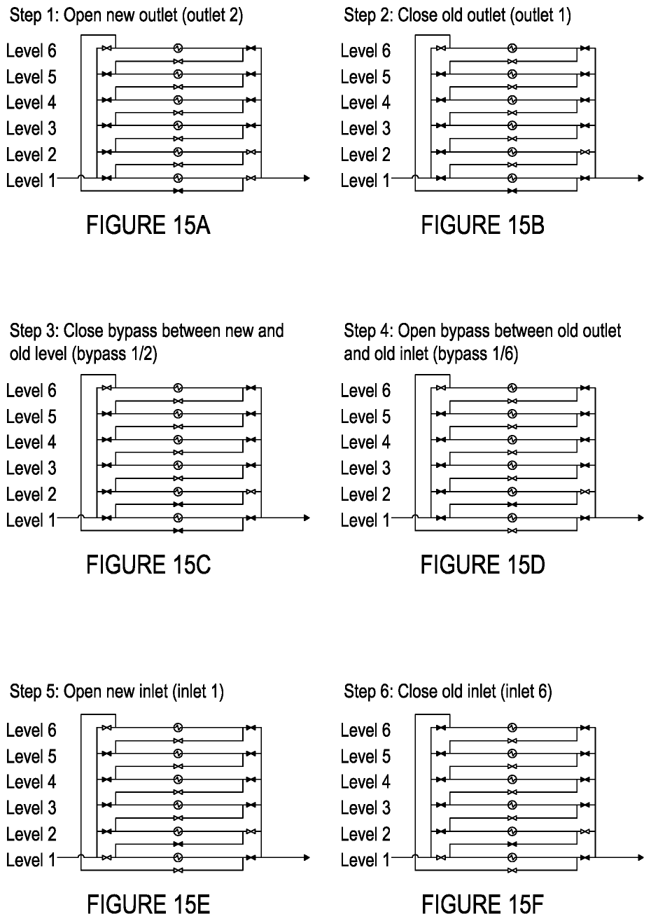

FIGS. 15A to 15F are process diagrams of various steps of a transition sequence between a first flow configuration of a spool cooler, in which the inlet position is at level 6 and the outlet position is at level 1, to a second flow configuration in which the inlet position is at level 1 and the outlet position is at level 2 (FIG. 15F). The first step (FIG. 15A) is to open the new outlet valve at level 2. Next, the previous outlet at level 1 is closed (FIG. 15B), and the cross-flow pipe between the previous and new outlet levels (levels 1 and 2) is closed (FIG. 15C). The cross-flow pipe between the previous outlet level and the previous inlet level (levels 1 and 6) is opened (FIG. 15D), and the new inlet is opened at level 1 (FIG. 15E). Finally, the old inlet at level 6 is closed (FIG. 15F).

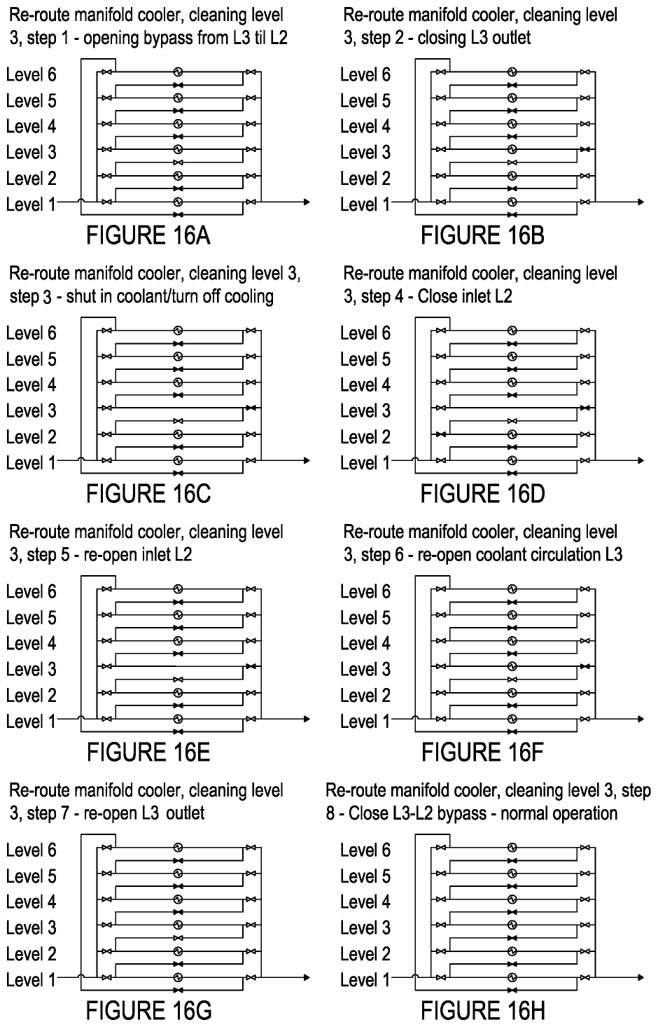

FIGS. 16A to 16H are process diagrams of various steps of a transition sequence between a normal production flow configuration of a manifold cooler, through cleaning of the pipe section at level 3, back to normal production flow (FIG. 16H). The first step (FIG. 16A) is to open the cross-flow pipe between the pipe section to be cleaned at level 3 and the level 2 pipe section. Next, the outlet at level 3 is closed (FIG. 16B), and the coolant flow around the level 3 pipe section is contained to cause the pipe section to be cleaned (FIG. 16C). The inlet to the level 2 pipe section is closed (FIG. 16D), and pipe section at level 3 is cleaned. After cleaning, the procedure is reversed, to re-open the inlet to level 2 (FIG. 16E), re-open coolant flow around the level 3 pipe section (FIG. 16F), and re-open the level 3 outlet (FIG. 16G). Finally, the cross-flow pipe between level 3 and level 2 is closed, and normal production is re-established (FIG. 16H).

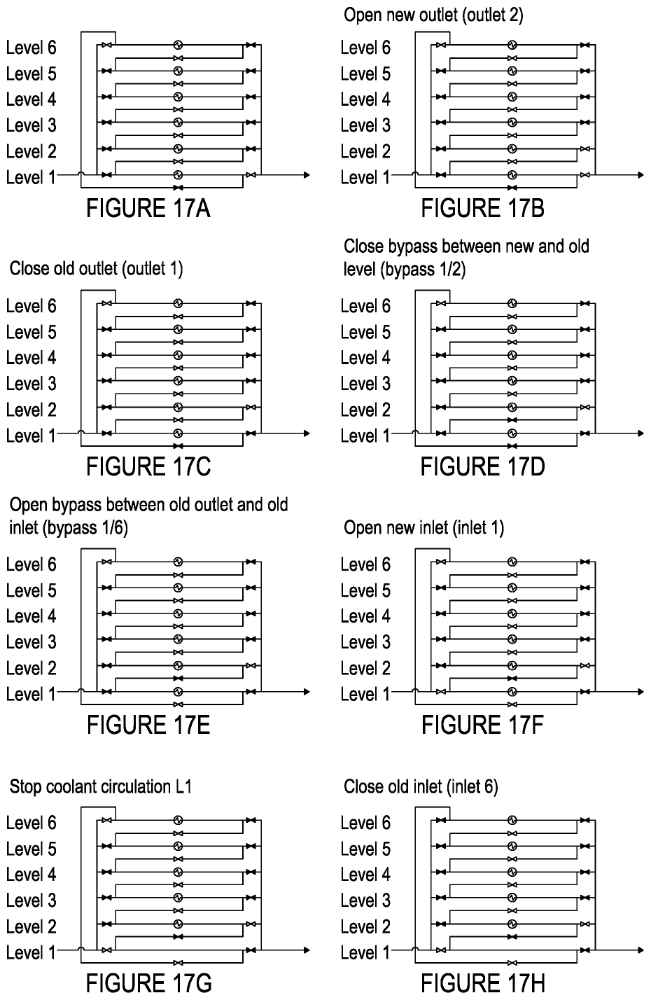

FIGS. 17A to 17H are process diagrams of various steps of a transition sequence between a first flow configuration of a spool cooler, in which the inlet position is at level 6 and the outlet position is at level 1 (FIG. 17A), to a second flow configuration in which the inlet position is at level 1 and the outlet position is at level 2 (FIG. 17H), incorporating coolant flow control. The first step (FIG. 17B) is to open the new outlet valve at level 2. Next, the previous outlet at level 1 is closed (FIG. 17C), and the cross-flow pipe between the previous and new outlet levels (levels 1 and 2) is closed (FIG. 17D). The cross-flow pipe between the previous outlet level and the previous inlet level (levels 1 and 6) is opened (FIG. 17E), and the new inlet is opened at level 1 (FIG. 17F). The coolant flow around the level 1 pipe section is contained to cause the pipe section to be cleaned (FIG. 17G). The inlet to the level 6 pipe section is closed (FIG. 17H), and pipe section at level 3 is cleaned. After cleaning, the coolant flow around the level 1 pipe section is reopened, and the transition to cleaning the next level can commence.

The soft transition between the flow configurations as described above mitigate against uneven exit temperatures for the process fluid. Alternatively, or in addition, the flow control valves used in the system may have soft open and/or close functions, and/or may enable choking of the flow to reduce the impact on pressure and temperature changes in the system.

Various optional features may be incorporated into embodiments of the invention. For example, during operation of the cooler, optional pressure sensors may measure pressure of the fluid in the cooler conduits, and send pressure data to a processor. The pressure data may be processed to monitor over time a differential pressure over the cooler conduit system. An increase in the differential pressure over the cooler conduits will be indicative of a build-up of solids on the inner walls of the conduits, which can be indicative of an incorrect or sub-optimal cleaning or seeding regime. Conversely, a stable or slowly changing differential pressure can be indicative of effective cleaning in the system to avoid or mitigate solid build ups.

In addition, or as an alternative, temperature sensors may be distributed over the length of the heat exchange conduit and may measure the temperature of the exterior of the conduit and send temperature data to a processor. The temperature data may be processed to measure and optionally monitor over time the external temperature of the conduit system. Reduced external temperatures may be indicative of reduced heat transfer through the walls of the conduit, due to build-up of wax and/or hydrate on the inner wall of the conduit. If internal temperature sensors are used instead of, or together with, the external temperature sensors, increased internal temperatures may be indicative of reduced heat transfer through the walls of the conduit, due to build-up of wax and/or hydrate on the inner wall of the conduit. Conversely, a stable or slowly changing temperature profiles can be indicative of effective cleaning in the system to avoid or mitigate solid layer build ups.

### Testing

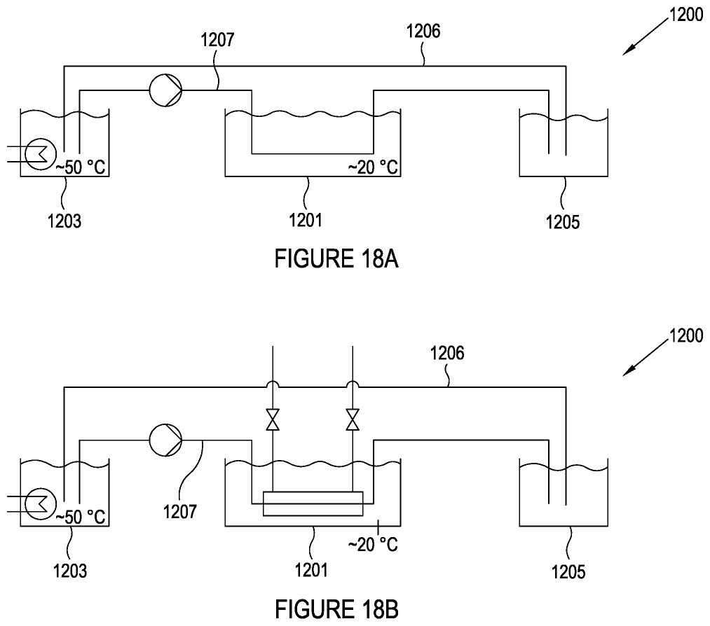

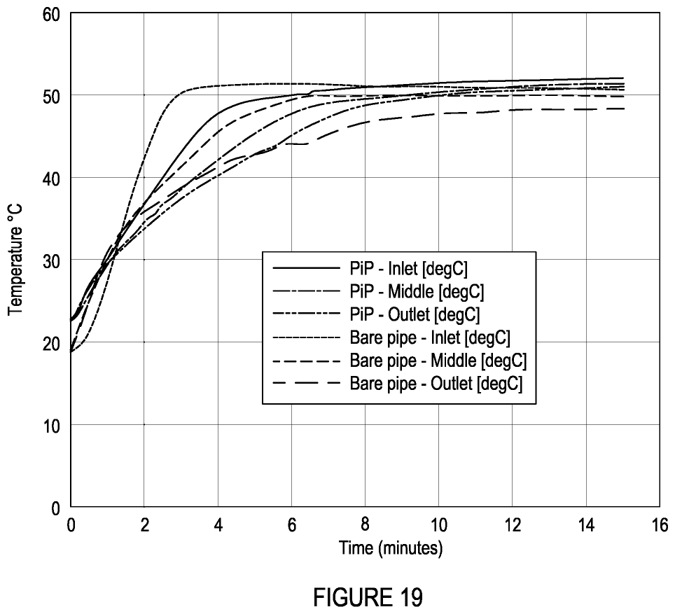

The principles of the invention and its embodiments were tested in an experimental set-up, schematically presented in FIGS. 18A and 18B. The testing system, generally depicted at 1200, comprised a test tank 1201 containing water of around 20° C., a warm water reservoir 1203, with a water temperature of around 50° C., and an outlet tank 1205 for receiving released wax and water. Water is recycled from the tank 1205 to the tank 1203 via a return line 1206 and pump (not shown). In experimental set up A (FIG. 18A), a bare pipe 1207, which was lined with internal deposits of wax before testing, was disposed between the reservoir and the outlet tank, with a central portion submerged in the water of the test tank 1201. In experimental set up B (FIG. 18B), a pipe-in-pipe heat exchanger 1209 was located around a central portion of a wax-lined pipe disposed between the reservoir and the outlet tank. Temperature measurements were taken at the pipe wall at locations 40 cm from the pipe inlet, mid-pipe, and 40 cm from the pipe outlet. Results from the tests are shown in FIG. 19, which is a plot of temperature at the pipe wall against time for three positions on the pipe. The dashed lines are plots of the data from Test A, and the solid lines are plots of the data from Test B.

In Test A (FIG. 18A), water was pumped from the reservoir at a temperature of 57° C., along the waxed pipe, and to the outlet tank. In Test A, visual inspection confirmed that the wax was removed from the pipe by the effect of the warm inlet water. The plots show that the wax was removed relatively fast: most quickly from the pipe near the inlet, and most slowly from the pipe near the outlet. This demonstrated that the principle of rerouting the warm inlet flow to clean deposits from a pipe can be effective in its own right, where the fluid temperature is sufficiently high, and/or in step cooling applications.

In Test B (FIG. 18B), water was pumped from the reservoir at a temperature of 54° C., along the waxed pipe, and to the outlet tank, while the annulus water in the pipe-in-pipe heat exchanger was contained around the waxed pipe. In Test B, visual inspection confirmed that the wax was removed from the pipe by the effect of the warm inlet water, with very little residual wax. The plots show that the wax was removed very quickly: most quickly from the pipe near the inlet, and most slowly from the pipe near the outlet. The data show that the pipe is cleaned more quickly at its outlet end than in Test A. This demonstrated that the principle of containing the coolant medium around the pipe can increase the effectiveness of the inlet re-routing method. The data also show that the temperature at the outlet end in the Test B configuration is higher than in Test A. This indicates that with the same production fluid temperature, a longer section of pipe can be cleaned using contained coolant flow as replicated in Test B. This means that fewer sections and valves would be needed in the cooler apparatus. The results of Test B also indicate that the pipes can be cleaned with a relatively low flow temperature, extending the relevance of the technology to a greater number of applications.

The invention provides a cooler apparatus and a method use. The cooler apparatus has at least one heat exchange conduit passing through a cooling medium. The method comprises flowing a fluid to be cooled through the at least one heat exchange conduit from a first cooler inlet to a first cooler outlet, to cool the fluid from an inflow temperature to an exit temperature by heat exchange with the cooling medium. In an aspect of the invention, the flow of the fluid through the at least one heat exchange conduit and the flow of the cooling medium are controlled to cause a local increase in a temperature in a selected portion of the at least one heat exchange conduit. This causes deposits of solids to be released from an inner surface of the selected portion of the at least one heat exchange conduit into the flowing fluid. The method may comprise restricting or containing the cooling medium around the selected portion of the at least one heat exchange conduit, and/or controlling the flow of the fluid to be cooled by re-routing the flow path of the fluid through a selected inlet of the at least one heat exchange conduit.

It will be appreciated that many cooler configurations are within the scope of the invention, including but not limited to manifold coolers, spool coolers, shell-and-tube coolers, active and passive coolers, plate-coolers, and closed and open systems. In particular, a cooler apparatus of an embodiment of the invention comprises multiple heat exchange conduits arranged in parallel, each of similar form and function. Production fluid is then caused to flow through multiple heat exchange conduits in parallel, which increases the cooling capacity of the apparatus when required for the production fluid flow conditions. Flow into the multiple heat exchange conduits may be controlled by the provision of a manifold system with flow control valves, or by splitting the flow from a single inlet conduit. Such arrangements of parallel cooler conduits allow higher flow rates to be accommodated (for example during the early lifetime of a well), retaining throughput, without conduit diameters that create the desired turbulence in the fluid flowing through the cooler for effective operation. During a later time, if the flow rate of production fluid decreases, one or more of the cooler conduits can be taken offline. The reduction in flow area through the cooler system enables turbulent flow to be maintained at the lower production flow rate. Such parallel conduit systems could be configured as manifold flow coolers, spool coolers, helix coolers, and/or box coolers. In each case, each parallel cooler conduit would have a respective return line and secondary inlet system for seeding. The invention has application to cold flow systems, subsea coolers, and step coolers used generally to lower the temperature of a fluid and stimulate precipitation of solids upstream of items of processing equipment (to an extent required by that processing equipment).

The principles of the invention are applicable to a range of cooler applications. For example, in high temperature hydrocarbon production wells (i.e. flow temperatures greater than around 100° C. to 120° C., a derating step-down cooler may be used to reduce the temperature to under around 100° C. to 90° C. (or less), for example to enable a longer lifetime for downstream equipment and/or the use of less expensive downstream equipment. Derating coolers are also often needed after a compressor, pump or boosting equipment, which adds pressure and therefore temperature to the fluid. Temperatures may be for example over 100° C. to 120° C., and the cooler is configured to lower the temperature to below 100° C. to 90° C. Although the exit temperatures in these applications would be over the WAT and HET, in some cases deposits will be formed on the relatively cold pipe walls. Alternatively or in addition, step coolers may be used for condensation of liquids before (or after) gas-liquid separation or compressors. In this application, the outlet temperature of around 60° C. to 40° C. is usually above the WAT and HET, but is sufficiently close that there will typically be depositing on the colder pipe walls.

The invention also applies to cold flow applications, where the exit temperature is close to the ambient temperature of the environment surrounding the cooler and/or outlet flowline, and where substantial amounts of both wax and/or hydrates must be removed to achieve inert outlet flow. Cold flow configurations could be applied to multiphase or single-phase production of gas, produced water, condensate and oil. This is beneficial both under normal production and in the case of shut-downs, in which one often would need to inject larger amounts of inhibitor chemicals to avoid potential of plugging in the downstream pipes (mainly hydrates).

Cooler apparatus and/or methods of embodiments of the invention are flexible in their operation, and can be configured as manifold coolers, spool coolers, or hybrid coolers. In some embodiments, sections of the cooler can be shut down and/or reopened to address varying production rates, fluid compositions, temperature variations and/or other parameters that may change during a fluid cooling operation (for example over the field life of a hydrocarbon producing well).

It will be appreciated that although cooler configurations are described that are flexible and configurable, principles of aspects of the invention, including the flow control of coolant, and re-directing of inlets and/or outlets, are applicable to dedicated cooler set-ups. In other words, the inventive principles extend to apparatus and methods that are permanently or semi-permanently configured as spool coolers, manifold coolers, or hybrid coolers, and are not limited to the flexible flow configurations described herein.

Selected embodiments of the invention use measurements from temperature and/or pressure sensors to verify and/or monitor performance of the system. In alternative modes of use, for example in the absence of sensors, a system operator would be able to detect a problem with flow from the well, and would be able to adjust operating parameters to address the problem.

Variations to the described embodiments may include equipment for collecting and/or removing solids from flowing fluid in the system. Examples of possible equipment include solid-liquid separators such as cyclone units, filters, or skimmers configured to remove solids from the bulk flow of hydrocarbons. The solid removal equipment may include multiple units or stages in parallel or in series, and may operate continuously or semi-continuously. The equipment may be located at strategically selected parts of the flow system, for example upstream of equipment sensitive to solids in the flow such as compressors, and/or upstream of the cooler apparatus.

A further variation to the described examples may include additional systems or components for cleaning or otherwise mitigating against build-up of deposits on the return conduit of a seeding system, for example an internal pig, heat tracing elements, or a hot oil flushing system in accordance with prior art (see for example as disclosed in WO 2012/093079). These may be a part of the general cleaning system, or may be dedicated systems or components for the return conduit.

In general, embodiments of the invention utilise locally-available thermal energy from the process fluid to clean meltable deposits from the cooler apparatus, without dependence on an external source of thermal energy. Some embodiments of the invention are substantially passive, requiring considerably reduced energy usage (for example for actuation of flow control valves) compared with presently available techniques. However, it will be appreciated that the principles of utilising thermal energy from the process fluid in the cleaning operations can be used in combination with active systems in embodiments of the invention. For example, the coolant control methods described herein may be used in combination with active pumping of coolant between compartments, to improve efficiency and/or to increase the effect of external cleaning. Active cleaning methods for the exterior of the cooler pipes may be used, such as using AUV, ROV or robotic cleaning systems, jetting, vibration of pipes, pulsed water pressure, or flushing a pipe-in-pipe system with turbulent flow in the annulus. Cleaning of coolant compartments can also be carried out using chemicals if required. The cleaning equipment can be integrated into the cooler or can be operated as a separate system.

Alternative flow configurations may comprise an oil/water separator between the wellhead and the cooler inlet conduit, and water separated from the fluid by the separator may be discharged, transported, or reinjected into the well, or into a dedicated well for receiving produced water. Alternatively, or in addition, a gas/liquid separator, or a multi-phase separator may be used upstream of the cooler apparatus, and the described cooler apparatus and methods may be used in the cooling of separated gas and liquid streams. The apparatus and methods of the invention may therefore be applied to multiphase fluid systems. Outlet flow streams from the separators may be transported in separate pipes, or may be reinjected, or may be combined for export, and the described cooler apparatus and methods may be applied to any or all of the gas, liquid hydrocarbon, and water flow streams. Other optional equipment that may be used in flow systems that utilise the cooler apparatus and methods of the invention include desanders or other solid knock-out equipment, slug catchers, samplers, separators and/or mixers upstream of the cooler to improve the homogeneity of the flow in the cooler pipes. Such functionality may for example be integrated into the inlet manifold of a cooler.

The invention extends to combinations of features other than those expressly described herein.

1. A method of cooling a fluid using a cooler apparatus having at least one heat exchange conduit passing through a cooling medium, the method comprising:
flowing a fluid to be cooled through the at least one heat exchange conduit from a first cooler inlet to a first cooler outlet, to cool the fluid from an inflow temperature to an exit temperature by heat exchange with the cooling medium;
controlling the flow of the fluid through the at least one heat exchange conduit and the flow of the cooling medium, to cause a local increase in a temperature in a selected portion of the at least one heat exchange conduit, thereby releasing deposits of solids from an inner surface of the selected portion of the at least one heat exchange conduit into the flowing fluid.

2. The method according to claim 1, comprising changing the flow of the fluid and/or the flow of the cooling medium cyclically, to cause a cycle of local increases in a temperature in a plurality of selected portions of the at least one heat exchange conduit.

3. The method according to claim 1, comprising restricting or containing the cooling medium around the selected portion of the at least one heat exchange conduit.

4. The method according to claim 1, wherein the cooler apparatus comprises a plurality of compartments, each compartment at least partially surrounding a portion of the cooler apparatus, and wherein the method comprises controlling the flow of the cooling medium into and/or out of a selected compartment to cause the local increase in a temperature in the selected portion of the at least one heat exchange conduit.

5. The method according to claim 4, comprising restricting or containing the convection throughflow of the cooling medium through the compartments by closing one or more gates or valves of the flow control system.

6. The method according to claim 4, comprising regulating flow of the cooling medium through the compartments by controlling a pump.

7. The method according to claim 4, comprising flowing the cooling medium between a first compartment to a second compartment.

8. The method according to claim 7, comprising circulating the cooling medium between a first compartment and a second compartment.

9. The method according to claim 1, comprising causing the cooling medium to flow relative to the heat exchange conduit to remove material or debris from an external surface of the heat exchange conduit.

10. The method according to claim 1, comprising removing material or debris from an external surface of the cooler apparatus using an exterior cleaning system.

11. The method according to claim 1, comprising controlling the flow of the fluid to be cooled by re-routing the flow path of the fluid through a selected inlet of the at least one heat exchange conduit, wherein the selected inlet is at or near the selected portion of the at least one heat exchange conduit to be cleaned, and the method comprises directing substantially uncooled fluid to the selected portion to deliver thermal energy to the selected portion.

12. (canceled)

13. The method according to claim 1, comprising controlling the flow of the fluid to be cooled by re-routing the fluid flowing in the cooler apparatus to flow through a selected outlet of the at least one heat exchange conduit.

14. The method according to claim 13, comprising selecting the outlet to maintain the exit temperature within a desired temperature range.

15. The method according to claim 1, wherein the cooler apparatus comprises a plurality of heat exchange conduits operating in parallel, and the selected portion is a selected heat exchange conduit of the plurality of heat exchange conduits, and wherein the method comprises directing fluid from the selected heat exchange conduit to a second inlet, to flow into another of the plurality of heat exchange conduits.

16. A cooler apparatus comprising:
at least one heat exchange conduit passing through a cooling medium, the at least one heat exchange conduit comprising a first cooler inlet and a first cooler outlet, arranged to cool a process fluid from an inflow temperature to an exit temperature by heat exchange with the cooling medium;
a flow control system for controlling the flow of the process fluid and the flow of the cooling medium to cause a local increase in a temperature in a selected portion of the cooler apparatus, thereby releasing deposits of solids from an inner surface of the selected portion of the at least one heat exchange conduit into the flowing fluid.

17. The cooler apparatus according to claim 16, comprising a plurality of pipe sections defining the at least one heat exchange conduit, wherein at least some of the plurality of pipe sections are configurable to be fluidly connected in series to form a heat exchange conduit from the plurality of pipe sections.

18. (canceled)

19. The cooler apparatus according to claim 16, comprising a plurality of pipe sections defining the at least one heat exchange conduit, wherein at least some of the plurality of pipe sections are operable in parallel to form a plurality of heat exchange conduits from the plurality of pipe sections.

20. The cooler apparatus according to claim 16, comprising a plurality of compartments, each compartment at least partially surrounding a portion of the at least one heat exchange conduit, and wherein the flow control system is configured to control the flow of the cooling medium into and/or out of a selected compartment to cause the local increase in a temperature in the selected portion of the at least one heat exchange conduit.

21. The cooler apparatus according to claim 20, wherein the flow control system is operable to restrict or contain throughflow of the cooling medium through the compartments by closing one or more gates or valves.

22. The cooler apparatus according to claim 20, wherein the flow control system is operable to regulate flow of the cooling medium through the compartments by controlling a pump.

23. The cooler apparatus according to claim 20, wherein the plurality of compartments is arranged to enable the cooling medium to flow between a first compartment and a second compartment.

24. (canceled)

25. (canceled)

26. The cooler apparatus according to claim 16, further comprising a cleaning system for cleaning the exterior of the cooler apparatus.

27. (canceled)

28. (canceled)

29. A cooler system comprising a plurality of cooler apparatuses according to claim 16, wherein the cooler apparatuses are arranged to operate in parallel to cool the process fluid.

30. A cooler system comprising a plurality of cooler apparatuses according to claim 16, wherein the cooler apparatuses are arranged to operate in series to cool the process fluid.

31. A subsea flow system comprising a source of hydrocarbon fluids, at least one cooler apparatus according to claim 16, wherein the at least one cooler apparatus is fluidly connected to the source for receiving hydrocarbon fluids to be cooled, and an exit flowline for receiving cooled hydrocarbon fluids from the at least one cooler apparatus.

32. (canceled)
